(19) United States
(12) Patent Application Publication
(10) Pub. No.: US 2026/0329073 A1
(43) Pub. Date: Oct. 22, 2026

(54) METHOD AND CONTROL DEVICE FOR TRAJECTORY REGULATION OF A LISSAJOUS MICROSCANNER

(71) Applicant: OQMENTED GMBH, Itzehoe (DE)

(72) Inventors: Marcel REHER, Kiel (DE); Peter BLICHARSKI, Essen (DE); Ulrich HOFMANN, Itzehoe (DE); Thomas VON WANTOCH, Kiel (DE)

(21) Appl. No.: 19/101,463

(22) PCT Filed: Jul. 26, 2023
(86) PCT No.: PCT/EP2023/070742

§ 371 Date: Feb. 5, 2025

(30) Foreign Application Priority Data
Aug. 8, 2022 (DE) 102022119946.0

(51) Int. Cl. G02B 26/10

(52) U.S. Cl. CPC G02B 26/101

(57) ABSTRACT

In a method for trajectory regulation of a two-axis Lissajous micro-scanner, a drive device for the micro-scanner is controlled in the sense of a regulation, such that over a plurality of consecutive time intervals in each of the time intervals for its respective duration the drive frequencies for the two axes form a frequency pair and the respectively assigned frequency pairs from immediately consecutive time intervals differ at least with respect to at least one of the frequencies. For a respective time interval, its frequency pair is selected from a predetermined discrete set of several different frequency pairs according to a selection rule as a function of a sensor-detected value of at least one physical variable which is in a dependency relationship with the respective resonance frequency with respect to at least one of the oscillation axes, such that the selected frequency pair deviates with respect to at least one of its two frequencies by a respective frequency deviation from the resonance frequency relative to the same oscillation axis according to the dependency relationship with the detected value of the at least one variable.

The present invention relates to a method and a control device for operating a Lissajous micro-scanner system, a computer program (product) for operating the control device, and a beam deflection system based on the control device.

Micro-scanners, which are also referred to in technical terms in particular as “MEMS scanners”, “MEMS mirrors”, or “micromirrors”, or in English in particular as “micro-scanner” or “micro-scanning mirror” or “MEMS mirror”, are micro-electro-mechanical systems (MEMS) or more specifically micro-opto-electro-mechanical systems (MOEMS) from the class of micromirror actuators for dynamic modulation of electromagnetic radiation, in particular of visible light. Depending on the design, the modulating movement of an individual mirror can be translational or rotational around at least one axis. In the first case, a phase-shifting effect is achieved, and in the second case, the deflection of the incident electromagnetic radiation is achieved. Micro-scanners are also considered, in which the modulating movement of an individual mirror is, at least also, rotational. In micro-scanners, the modulation is typically generated via a single mirror for each MEMS-element (micro-scanner), in contrast to mirror arrays, in which the modulation of incident light occurs via the interaction of multiple mirrors on a single MEMS-element.

Micro-scanners may thus be used in particular to deflect electromagnetic radiation in order to modulate an electromagnetic beam incident thereon with respect to its deflection direction by means of a deflection element (“mirror”). This can be used in particular to achieve a Lissajous projection of the beam into an observation field or projection field. For example, imaging sensory tasks can thus be achieved or display functionalities can be implemented. In addition, such micro-scanners can also be used to irradiate materials in an advantageous manner and thus also process them. Other possible applications are in the area of lighting or illuminating certain open or closed spaces or areas of spaces using electromagnetic radiation, for example in the context of headlight applications.

In many cases, micro-scanners consist of a mirror plate (deflection plate) that is suspended laterally on elastically stretchable springs. A distinction is made between single-axis mirrors, which should preferably only be suspended so as to be rotatable about a single axis, and two-axis and multi-axis mirrors, in which rotations, in particular rotational oscillations, are possible about a corresponding number of different axes, in particular simultaneously.

A micro-scanner system for deflecting an electromagnetic beam can thus in particular have a two-axis micro-scanner, i.e. a micro-scanner with two different, in particular mutually orthogonal, oscillation axes or a combination of multiple individual, in particular two, single-axis micro-scanners, which are arranged such that the incident beam can be deflected in succession by the various individual micro-scanners of the micro-scanner system. In a micro-scanner system with a combination of two or three single-axis micro-scanners, their oscillation axes can be orthogonal to each other, particularly in pairs.

Both in the case of imaging sensors and in the case of a display function, a micro-scanner is used to deflect electromagnetic radiation such as a laser beam or a shaped beam from any other source of electromagnetic radiation at least in two dimensions, for example horizontally and vertically, in order to thus scan or illuminate an object surface within an observation field. In particular, this can be done in such a way that the scanned laser beam sweeps over a rectangular surface on a projection surface in the projection field. In these applications, micro-scanner systems having at least one two-axis micro-scanner or having multiple, in particular two, single-axis micro-scanners connected in succession in the optical path are used. The wavelength range of the radiation to be deflected can in principle be selected from the entire spectrum of short-wave UV radiation, through the VIS range, NIR range, IR range, FIR range up to long-wave Terahertz and radar radiation.

Electrostatic, electromagnetic, piezoelectric, thermal, or other actuator principles are typically used as drives. The mirror movement can in particular be quasi-static (in particular non-resonant) or resonant, the latter in particular in order to achieve greater oscillation amplitudes, greater deflections, and higher optical resolutions. In addition, in resonant operation, energy consumption can in principle be minimized or advantages can be achieved, particularly in terms of stability, robustness, manufacturing yield, etc. Scan frequencies from 0 Hz (quasi-static) up to over 100 kHz (resonant) are typical.

Although the micro-scanner systems and micro-scanners according to the invention described herein can in principle be used reasonably and successfully in many different areas, their application in the area of laser projection displays will be discussed in particular hereinafter, only for explaining the solution and without this having to be interpreted as a limitation of the application area.

In many known cases, micro-scanner-based laser projection displays are so-called raster scan displays, in which a first beam deflection axis is operated at high frequency in resonance (typically 15 kHz to 30 kHz) (fast axis) to generate the horizontal deflection and a second axis is operated quasi-statically at low frequency (typically 30 Hz to 60 Hz) to generate the vertical deflection. The trajectory of a beam deflected in this way corresponds to a fixed predetermined grid-like line pattern. It is typically reproduced 30 to 60 times per second.

A different approach is used in the so-called Lissajous micro-scanners or Lissajous micro-scanner systems, in particular also in Lissajous scan displays. There, both axes are usually operated in resonance and a trajectory in the form of a Lissajous figure is created. In this way, large amplitudes can be achieved in both axes. The vertical deflection in particular can therefore be much larger than with a raster scanner. Accordingly, with a Lissajous micro-scanner, in particular a Lissajous scan display, a significantly higher optical resolution can usually be achieved than with a raster scan display, especially in the vertical direction.

A deflection device for a projection system for projecting Lissajous figures onto an observation field is known from EP 2 514 211 B1, which device is designed to deflect a light beam around at least a first and a second deflection axis to generate Lissajous figures.

The present invention is based on the object of further improving the control of Lissajous micro-scanners for their operation, in particular with regard to applications in the field of projection displays, in particular with regard to the most uniform possible illumination of the observation field.

This object is achieved according to the teaching of the independent claims. Various embodiments and developments of the solution are the subject matter of the dependent claims.

A first aspect of the solution relates to a method for trajectory regulation in a multi-axis micro-scanner system. The method comprises: controlling a drive device for the micro-scanner system such that it is caused to drive a first rotary oscillation of a deflection element of the micro-scanner system about a first oscillation axis by means of an excitation with a first drive frequency and, simultaneously with the first oscillation, a second rotary oscillation of a deflection element of the micro-scanner system about a second oscillation axis orthogonal to the first oscillation axis by means of an excitation with a second drive frequency. The control takes place over a number of consecutive time intervals in the sense of a regulation, such that:
(i) in each of the time intervals for its respective duration, the first and the second drive frequency are each kept stable at a respective specific first and second target frequency, in particular by a phase-locked loop, wherein these two target frequencies form a frequency pair associated with this time interval and the respectively assigned frequency pairs of at least two immediately consecutive time intervals differ from one another with respect to the first target frequency and/or the second target frequency; and
(ii) for a respective time interval, the frequency pair associated with it is selected from a predetermined discrete set of several different frequency pairs according to a selection rule as a function of a sensor-detected value of at least one physical variable which is in a dependency relationship with the respective resonance frequency with respect to at least one of the oscillation axes, such that the selected frequency pair deviates with respect to at least one of its two frequencies by a respective frequency deviation from the resonance frequency corresponding to the same oscillation axis according to the dependency relationship with the detected value of the at least one variable.

The term “micro-scanner system” (and variations thereof) as used herein means a device or a system constructed from several cooperating devices which has at least one micro-scanner. In particular, both a single, in particular two-axis, micro-scanner and an arrangement with two or more, in particular single-axis, micro-scanners, which is configured to deflect an incident electromagnetic beam sequentially by means of the two or more micro-scanners, are accordingly each a micro-scanner system.

A “deflection element” (and variations thereof) as defined herein is understood in particular as a body which has a reflective surface (mirror surface) that is smooth enough that electromagnetic radiation, such as visible light, reflected on the mirror surface, retains its parallelism under the law of reflection and thus allows an image to be reproduced. The roughness of the mirror surface has to be less than approximately half the wavelength of the electromagnetic radiation. The deflection element can in particular be designed as a mirror plate having at least one mirror surface or can include such a mirror plate. In particular, the mirror surface itself can consist of a different material, for example of a metal, which is in particular deposited (such as by chemical vapor deposition (CVD) or sputtering), than the rest of the body of the deflection element. In the aforementioned micro-scanner system according to the solution, the first oscillation and the second oscillation can either refer to a same, thus multi-axis, deflection element of the micro-scanner system, or to different deflection elements arranged in a same beam path, in particular deflection elements of single-axis micro-scanners of the micro-scanner system.

A “Lissajous projection” (and variations thereof) as defined herein is to be understood in particular as scanning of an observation field with the aid of electromagnetic radiation, which is achieved by at least two mutually orthogonal sinusoidal oscillations of a deflection device deflecting the radiation into the field of observation, in particular of an at least two-axis micro-scanner system.

The term “non-linear Lissajous projection” (and variations thereof), as used herein, is to be understood as a special case of a Lissajous projection (and thus also falling under the term “Lissajous projection” herein), in particular a scanning or illumination of an observation field with the aid of electromagnetic radiation, which is effected by at least two mutually orthogonal sinusoidal oscillations about an associated oscillation axis of a deflection device which deflects the radiation into the observation field, in particular an at least two-axis micro-scanner system. In this case, at least a first of these oscillations with respect to a first oscillation axis is modulated in its amplitude depending on the instantaneous amplitude of an oscillation with respect to at least one other oscillation axis, so that at least the first oscillation does not represent a linear oscillation and thus does not follow Hooke's law with an amplitude-independent spring constant.

The term “axis” or, equivalently, “axis of oscillation” (and variations thereof), as used herein, means an axis of rotation (rotation axis) of a rotational movement, in particular an oscillating rotational movement. It is thus a straight line that defines or describes a rotation or twisting.

The term “drive device” (and modifications thereof), as used herein, is to be understood in particular as a device which has one or more actuators for driving the deflection unit, i.e. the simultaneous rotary oscillations of the deflection element of a multi-axis micro-scanner relative to a support structure on which the deflection element is suspended in an oscillatory manner, and with respect to at least the first and the second, and optionally also a third, oscillation axis. In the case of a micro-scanner system with multiple micro-scanners, a drive device can also be understood in particular as a device which has one or more actuators for driving the respective deflection units of these micro-scanners.

The term “phase pass” (and variations thereof) as used herein is to be understood in particular as a time period which is defined as the period between an occurrence and a first subsequent occurrence of a certain identical phase position pair formed from the phases for the first and the second oscillation. Especially in the case of closed trajectories of the electromagnetic beam deflected by the micro-scanner system, one phase pass corresponds exactly to one complete phase pass through the corresponding Lissajous figure.

The term “dependence relationship” between two variables (and variations thereof), as used herein, means that at least one of the two variables depends on the other variable. The dependency can be expressed in particular in the sense of a mathematical function or more generally in the sense of a relation or correlation. What is crucial in this case is that a resonance frequency dependent on the measured value of the at least one variable can be deduced from the same. The dependence can be unilateral or mutual.

The discrete set of frequency pairs can in particular be defined explicitly by means of its elements (frequency pairs or corresponding pairs of frequency deviations with respect to a reference frequency pair) or implicitly by a generation rule by means of which the elements of the set can be generated.

The term “selection rule” (and variations thereof), as used herein, is to be understood in particular as a fixed rule according to which an element of the discrete set of frequency pairs, i.e. a specific frequency pair, can be unambiguously selected depending on the value of the physical variable detected by the sensor. The selection rule can be implemented in particular in the sense of a table-like relation in which each element of a set of possible values or value ranges for the physical variable is assigned a specific frequency pair from the discrete set of frequency pairs. However, the selection rule can also be defined in particular in the sense of a calculation rule by means of which an output variable can be calculated using a respective value for the physical variable or, if applicable, for each of a plurality of physical variables used as input variable(s), which output variable is uniquely associated with a specific frequency pair of the discrete set of frequency pairs, for example as an index to the discrete set or already as the selected frequency pair itself.

As possibly used herein, the terms “comprises,” “contains,” “includes,” “has”, “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”. The terms “another” and “a further” and any other variant thereof are to be understood to mean “at least one other”.

The term “plurality” as used herein is to be understood to mean “two or more”.

In the context of the invention, “configured” or “configuration”, “set up” or modifications of these terms are to be understood as meaning that the corresponding device is already prepared or adjustable—i.e., configurable—to fulfill a specific function. The configuration or set up can take place, for example, via a corresponding setting of parameters of a process course or of hardware or software implemented switches or the like for activating or deactivating functionalities or settings. In particular, the device can have multiple predetermined configurations or operating modes, so that the configuration can be carried out by selecting one of these configurations or operating modes.

While conventional methods for operating Lissajous micro-scanner systems usually use a phase-locked loop for each oscillation axis in order to keep the oscillation in resonance with the associated oscillation axis, the method according to the first aspect is operated in such a way that at least with regard to one oscillation axis a drive frequency is used which differs from the associated resonance frequency for the same oscillation axis by a frequency deviation. By appropriately defining the discrete set of frequency pairs and the selection rule for them, certain properties of the resulting trajectory that deviate from pure resonance operation, in particular double-resonance operation, can be specifically adjusted on the one hand and maintained on the other hand by means of the regulation even with resonance frequencies that change over time. Such temporally variable resonance frequencies of the oscillation axes can arise, for example, due to temperature changes and the resulting changes in the moment of inertia of the deflection element or properties of its suspension.

In particular, it can thus be achieved that a Lissajous trajectory, that omits image areas in the observation field to be illuminated in a certain time interval, moves specifically into exactly these previously omitted image areas in the immediately following next time interval. This can be achieved here in particular by ensuring that, in the sense of a positive list determined by the discrete set, in principle only those trajectories are permitted for which exactly this is known in advance—in particular for relevant viewing periods, which are usually based on human perception and the frame rate of common video formats. In this way, the achievable image quality can be improved, since a more homogeneous trajectory density and thus a more homogeneous illumination of an observation field illuminated by the Lissajous figure as a whole can be achieved.

Preferred embodiments of the method are described hereinafter, which in each case, unless expressly excluded or technically impossible, can be combined as desired with one another and with the further described other aspects of the solution.

In some embodiments, according to the selection rule for the respective time interval, that frequency pair is selected from the set which, with respect to at least one of its two frequencies, has a frequency deviation from the resonance frequency to the same oscillation axis which is different from zero and minimal within the set and which corresponds to the detected value of the at least one variable according to the dependency relationship. Such a selection is particularly advantageous in that it results in a Lissajous figure for the new time interval the shape of which is very similar to that of the Lissajous figure in the preceding time interval, so that it can be placed particularly well in the image areas left free by this preceding Lissajous figure. In this way, a significant improvement can be achieved over the two time intervals with regard to the overall illumination level that can be achieved in this total period.

In some embodiments, the respective duration of each time interval corresponds to at least 90%, in particular at least 50%, preferably at least 80%, more preferably at least 95%, of the duration of a phase pass of a Lissajous trajectory caused by reflecting deflection of an electromagnetic beam incident on the micro-scanner system during the simultaneous oscillations into an observation field according to the frequency pair associated with the respective time interval. In this way, a high achievable level of illumination and thus a high image quality is also promoted. In some embodiments, the method further comprises determining at least one frequency pair {f₁; f₂} of the set depending on:
the resonance frequency f_{r,1} of the micro-scanner system for the first oscillation axis;
the resonance frequency f_{r,2} of the micro-scanner system for the second oscillation axis; and
at least one predetermined line spacing value or an upper limit defined therefor, which characterizes a maximum line spacing between adjacent lines of the Lissajous trajectory occurring during a complete phase pass.

In particular, a respectively associated upper limit can be defined for a line spacing along a direction parallel to the first oscillation axis and/or for a line spacing along a direction parallel to the second oscillation axis. The maximum line spacing in a Lissajous projection typically occurs at or near the center of the projection.

These embodiments are characterized in particular by the fact that they achieve a good homogeneity of illumination in a respective observation period (image frame) and also reach at least most, in particular all, pixels or image areas within a very short time, so that a very high image quality can be achieved with the associated Lissajous projection.

In particular, the determination of the at least one frequency pair {f₁; f₂} can be carried out starting from a phase pass frequency fᵣₑₛ which corresponds to a closed Lissajous trajectory for a pair {f_{0,1}, f_{0,2}} of possible resonance frequencies of the micro-scanner system for the two oscillations. The determination of the at least one frequency pair {f₁; f₂} comprises:
(i) determining a lower limit for a first factor n₁ associated with the first oscillation axis and/or a second factor n₂ associated with the second oscillation axis, each as a function of a line spacing value associated with the respective oscillation axis or the upper limit defined therefor, wherein n₁, n₂≥1 are each integers; and
(ii) determining the at least one frequency pair {f₁; f₂} in such a way that for this frequency pair or each of these frequency pairs the following conditions apply: f₁≤f_{0,1}/n₁; f₂≤f_{0,2}/n₂; and n₁, n₂ are coprimes.

In some alternative or cumulative embodiments (different frequency pairs could also be determined with different embodiments), the method further comprises determining at least one frequency pair {f₁; f₂} of the set in such a way that, starting from a phase pass frequency fᵣₑₛ, which corresponds to a closed Lissajous trajectory for a pair {f_{0,1},f_{0,2}} of—at least theoretically possible—resonance frequencies of the micro-scanner system for the two oscillations, and with |n_{Δ}|>1, the following applies:

$${f}_{1} = {f}_{0 , 1} + Δ {f}_{1} with Δ {f}_{1} = \frac{1}{{n}_{Δ} \cdot {n}_{2}} \cdot {f}_{res}$$

$${f}_{2} = {f}_{0 , 2} + Δ {f}_{2} with Δ {f}_{2} = \frac{1}{{n}_{Δ} \cdot {n}_{1}} \cdot {f}_{res} ,$$

wherein and n₁, n₂≥1 are each integers and coprimes, so that:

f_{0,1}=n₁·fᵣₑₛ and f_{0,2}=n₂·fᵣₑₛ.

In the above-mentioned manner, particularly suitable frequency pairs can be determined, without this being to be understood as a limitation, which are characterized in particular by the fact that a progression of the trajectory from time interval to time interval can be achieved in which, within a time interval, especially those image areas in the field of observation are illuminated which were not yet reached by the trajectory in the immediately preceding time interval.

The higher the value of |n_{Δ}| is chosen, the smaller the trajectory shift from time interval to time interval. In case |n_{Δ}|=2, trajectories can be achieved that are essentially centered in the image areas that were not yet illuminated in the immediately preceding time interval.

In some embodiments, the micro-scanner system comprises a deflection element that is suspended in such a way that it can oscillate such that it can perform the first rotational oscillation about the first oscillation axis and simultaneously the second rotational oscillation about the second oscillation axis. During the two simultaneous oscillations, an electromagnetic beam is directed at the deflection element in order to cause a Lissajous projection of the beam into an observation field by its reflection at the deflection element. The micro-scanner system can accordingly be designed in particular such that it has only a single, multi-axis micro-scanner.

In some other embodiments, the micro-scanner system comprises a first deflection element and a second deflection element, wherein the first deflection element is suspended in such a way that it can perform the first rotational oscillation about the first oscillation axis, and the second deflection element is suspended in such a way that it can perform a second rotational oscillation about the second oscillation axis simultaneously with the first oscillation. During the two simultaneous oscillations, an electromagnetic beam is directed at the first deflection element in order to cause a Lissajous projection of the beam into an observation field by its sequential reflection, first at the first deflection element and subsequently at the second deflection element. Such a micro-scanner system can thus in particular comprise two single-axis micro-scanners which can be used in the manner described above to sequentially deflect the electromagnetic beam, in particular to effect a Lissajous projection.

In some embodiments, the method further comprises modulating, in particular with respect to an intensity or wavelength, the electromagnetic beam by means of an image signal depending on the instantaneous deflection of the beam in such a way that the Lissajous projection with a certain image resolution of N pixels arranged in a matrix forms a two-dimensional digital image or a sequence of such images in the field of observation. In this case, according to the selection rule, for at least one, preferably each, of the time intervals, the frequency pair associated with it is selected from the set in such a way that within a maximum of five, preferably a maximum of three, immediately consecutive phase passes, each of the N pixels of the image resolution is imaged onto the observation surface (illumination condition).

The selection rule and/or the discrete set is/are defined in such a way that by means of the selection rule for the time interval(s) a frequency pair is selected such that the above illumination condition is met. The determination of the selection rule or the frequency pairs to be selected depending on the detected physical variable can be made in advance, for example in the context of a test series or characterization of the micro-scanner system, in such a way that it is known a priori that these frequency pairs meet the above-mentioned illumination condition when the corresponding value or values of the one or more sensor-detected physical variables occur. In these embodiments, compliance with the above-mentioned illumination condition can thus be ensured a priori.

In particular, during the respective duration of each time interval, the duration of a phase pass of a Lissajous trajectory according to the frequency pair associated with the respective time interval can be (selected) shorter than a shortest projection duration per image occurring during the respective time interval in a Lissajous projection by means of the micro-scanner system. In this way, a high image quality of the projected image or, if applicable, of a projected image sequence can be achieved, since the or each image is projected by means of at least one complete phase pass and thus by reaching at least a large proportion of all pixels, in particular all N pixels.

In some of the embodiments for image generation, according to the selection rule for at least one, preferably each, of the time intervals, the selection of the frequency pair associated with it from the set is carried out such that the selected frequency pair corresponds to a Lissajous trajectory resulting from the Lissajous projection, which trajectory passes through at least 90%, preferably at least 95% of the N pixels during a complete phase pass. In particular, this makes it possible to achieve a largely homogeneous illumination with just a single phase pass or phase pass. One or more frequency pairs that satisfy this condition can in turn be determined a priori for the specific micro-scanner system, in particular on the basis of its known resonance frequencies and their dependence on the at least one physical variable.

In some embodiments, the physical variable characterizes or depends on one of the following states of the micro-scanner system (in particular a section or component thereof) or a combination of at least two of these states or state changes: (i) a shift in a measured resonance frequency of at least one of the oscillations; (ii) a temperature; (iii) a mechanical stress or strain; (iv) an oscillation amplitude of the or a deflection element; (v) a phase instability occurring in at least one of the oscillations; (vi) an exceeding of the respective control variable of a phase-locked loop for the phase of at least one of the oscillations; (vii) a phase difference between a drive signal for controlling the drive device and a measurement signal that represents a measured deflection of the deflection element; (viii) a change in the incident electromagnetic radiation power that the deflection element acquires by absorption; (ix) an oscillation state of a reference oscillator in the micro-scanner system, or its change, wherein the oscillation state of the reference oscillator or its change correlates with an oscillation state of the or of the at least one deflection element or its change, in particular in a certain dependency relationship. Thus, for example after a prior calibration, the detected oscillation state of the reference oscillator or its change can be used to infer the oscillation state of the or at least one deflection element or its change. The oscillation state can be, in particular, an amplitude, a frequency and/or a phase of the respective oscillation or a combination of two or more of these variables.

What all these states or changes in state have in common is that, on the one hand, they can be easily detected by sensors and, on the other hand, they are dependent on the current resonance frequencies of the micro-scanner system and are therefore suitable as an input variable for controlling the drive frequency or drive frequencies.

In some embodiments, the value of the at least one physical variable depending on which the selection of the respective associated frequency pair for a respective time interval is made is detected during the time interval immediately preceding that time interval. This keeps the time between the selection of the frequency pair and its application to drive the micro-scanner system as short as possible, so that the selected frequency pair fits particularly well with the current resonance frequencies of the micro-scanner system, in particular with regard to an effective, in particular optimal, trajectory density regulation with regard to good illumination in order to achieve a trajectory density that is as constant as possible despite variable resonance frequency development.

In some embodiments, the change between immediately successive time intervals during the control takes place at a time at which the trajectory of the Lissajous projection has a distance from the center of the observation field illuminated by the trajectory within its complete phase pass that corresponds to at least 80%, preferably at least 90%, of the maximum occurring distance of a point on the trajectory from the center. This has the advantage that the change occurs in the outer area of the Lissajous figure, where it is typically not perceived by the observer at all, or at least less easily or as less disturbing than closer to the center of the illuminated observation field.

In some of these embodiments, the change specifically between successive time intervals within the scope of the control takes place at a point in time at which the trajectory of the Lissajous projection passes through an outer turning point of the trajectory. Here, the detectability of such a change for the observer is typically particularly low, so that the achievable quality of the image is particularly high despite the occurring frequency pair jumps and the resulting trajectory changes.

In some embodiments, the frequency pairs of the discrete set are stored in advance (“offline”) in a preferably non-volatile storage device and from this, for at least one of the time intervals, its associated frequency pair is selected depending on the sensor-detected value of the at least one physical variable according to the selection rule for each time interval. Thus, the frequency pairs of the discrete set can be determined in advance, for example as part of a measurement or characterization of the specific micro-scanner system to be operated according to the method, and stored in the storage device in a readable manner and thus kept available for later use in the operational operation of the micro-scanner system. This enables implementations with very high performance, since the frequency pairs do not have to be calculated during operation. Suitable frequency pairs can also be determined particularly precisely as elements of the discrete set, since more precise measuring methods and equipment can be used to measure or characterize the micro-scanner system under different conditions, such as temperatures or mechanical loads, for example under production or laboratory conditions, than in later operational use, where complex measuring devices are regularly not available and typically only the micro-scanner system's own measuring arrangement can be used, often with lower accuracy.

In some embodiments, as part of the control for at least one of the time intervals, the associated frequency pair is determined dynamically (“online”) during the course of the method by means of a calculation rule specified by the selection rule, which defines the discrete variable, depending on the sensor-detected value of the at least one physical variable. Here there is no longer a need for the above maintaining of pre-determined frequency pairs, which means that the storage capacity required for this and the pre-determination of frequency pairs before starting operations, in particular for display applications, can also be omitted.

In some embodiments, in addition to selecting a respective associated frequency pair for each time interval, a target amplitude gain associated with that time interval with respect to at least one of the two oscillation axes is also selected. In addition, during the respective time interval, the drive device is controlled including a respective amplitude gain configured by the associated target amplitude gain with respect to this at least one oscillation axis. In this way, reductions in the dimensions of the illuminated observation field (in particular perpendicular to the optical axis of the image), which could arise in one or more of the frequency pairs depending on the frequency deviations caused by the frequency pair selection, can be completely or at least partially compensated by a corresponding amplitude adjustment.

In some embodiments, the micro-scanner system is configurable such that its respective resonance frequency can be detuned with respect to at least one of the oscillation axes by appropriately adjusting at least one configuration parameter of the micro-scanner system. Within the scope of the method, in addition to selecting a respective associated frequency pair, a resonance frequency detuning of the micro-scanner system with respect to the at least one oscillation axis is then carried out for at least one of the time intervals by setting the at least one configuration parameter. This detuning of the resonance frequency to the respective affected oscillation axis can be used in particular instead of or cumulatively with the aforementioned amplitude amplification. In particular, the configuration parameter may refer to configurable properties of the moment of inertia of a relevant deflection element of the micro-scanner system or of the suspension of the deflection element. For example, the configuration can be achieved, at least in part, by bringing the micro-scanner system to a certain temperature level that corresponds to a certain resonance frequency of the micro-scanner system. It is also conceivable to configure the suspension of the deflection element(s) instead or cumulatively, by means of which an effective spring stiffness of the suspension is changed.

A second aspect of the solution relates to a control device for trajectory regulation of a micro-scanner system, wherein the control device is configured to control a drive device for a micro-scanner system according to the method according to the first aspect of the solution.

According to some embodiments, the control device can have, in particular for at least one of the two oscillation axes: (i) a phase-locked loop for stabilizing, in particular avoiding, a phase difference between a phase of the first or second oscillation corresponding to the oscillation axis and an associated control signal output by the phase-locked loop for the drive device with respect to the oscillation axis; and (ii) a frequency adjustment device for the phase-locked loop, in particular a computer program-controlled device, which is configured to adjust a reference variable of the phase-locked loop with respect to the oscillation axis as a function of a target frequency determined for this time interval according to the method according to the first aspect. In this way, a particularly efficient combination, in particular integration, of the process-based frequency adjustment with or into the phase regulation can be achieved.

A third aspect of the solution relates to a computer program with instructions which cause the aforementioned control device, in particular its frequency adjustment device, to carry out the method according to the first aspect of the solution.

The computer program can in particular be stored on a non-volatile data carrier. Preferably the data carrier is in the form of an optical data carrier or a flash storage module. This can be advantageous if the computer program as such is to be handled independently of a processor platform on which the one or more programs are to be executed. In another implementation, the computer program can be present as a file on a data processing unit, in particular on a server, and can be downloaded via a data connection, for example the Internet or a dedicated data connection, such as a proprietary or local network. In addition, the computer program can have a plurality of interacting individual program modules.

The control device according to the second aspect can accordingly have a program memory in which the computer program (according to the third aspect) is stored. Alternatively, the control device can also be set up to access a computer program available externally, for example on one or more servers or other data processing units, via a communication connection, in particular in order to exchange data therewith, which data are used during the execution of the method or computer program or represent outputs of the computer program.

A fourth aspect of the solution relates to a beam deflection system, comprising: (i) a multi-axis micro-scanner system with at least one deflection element that can perform a first rotary oscillation about a first oscillation axis, and with at least one deflection element that can perform a second rotary oscillation about a second oscillation axis orthogonal to the first oscillation axis simultaneously with the first oscillation in order to cause a Lissajous projection into an observation field by reflectively deflecting an electromagnetic beam incident on the micro-scanner system during the simultaneous oscillations; (ii) a drive device for driving at least one of the oscillations of the micro-scanner system; and (iii) a control device according to the second aspect for controlling the drive device according to the method according to the first aspect.

In some embodiments, the quality factor (also frequently defined as Q factor) of the micro-scanner with respect to at least one of the two oscillations is at least 1000. This can be achieved in particular by using a hermetic encapsulation of the associated micro-scanner or the associated micro-scanners of the micro-scanner system, in which the oscillating components, in particular the respective deflection element with its suspension, are arranged in an interior space defined by the encapsulation, in which a gas pressure below atmospheric pressure, in particular a vacuum, prevails. There, only a correspondingly low damping of the oscillations of the deflection element occurs and, in particular, large deflection angles of the deflection element can be achieved in a stable manner during its oscillations and thus a stable, large illuminated observation field.

The features and advantages explained with respect to the first aspect of the solution also apply correspondingly to the further aspects of the solution.

Further advantages, features, and possible applications of the present invention result from the following more detailed description in conjunction with the figures.

In the figures:

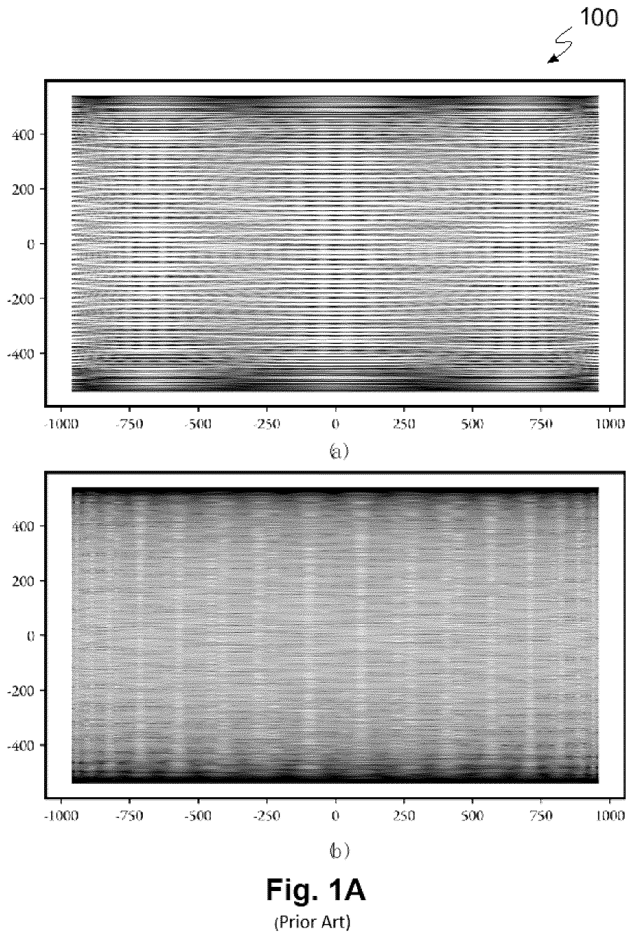

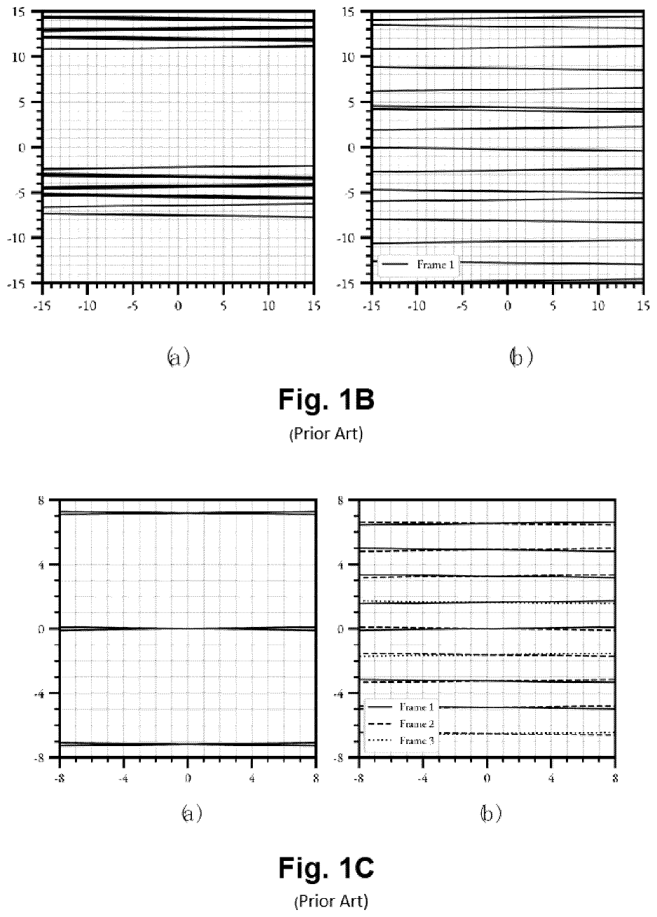

FIGS. 1A-C show various exemplary trajectories and trajectory sections of a Lissajous projection onto a projection surface in an observation field to be illuminated with a two-axis micro-scanner of the prior art;

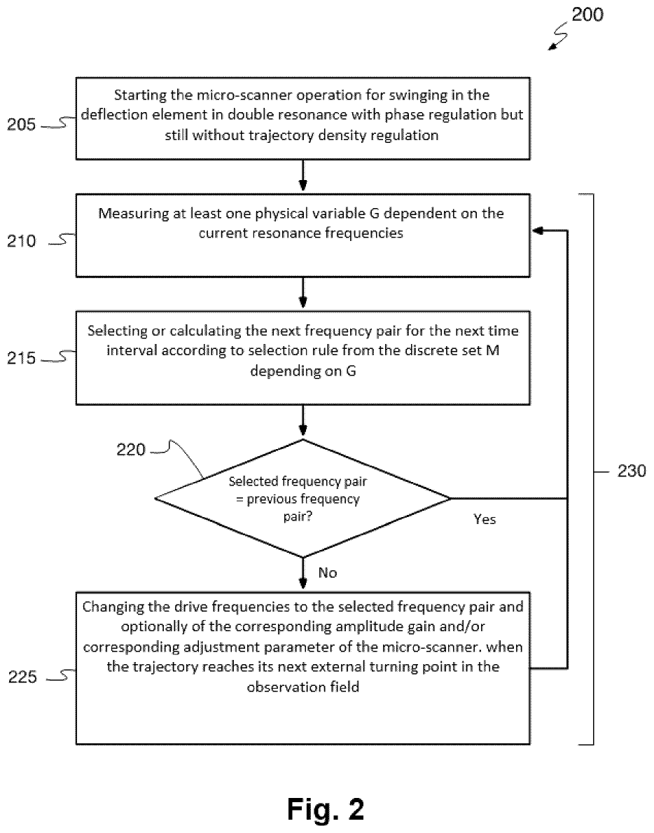

FIG. 2 shows a flow chart illustrating a preferred embodiment of the method according to the solution when using a micro-scanner system with a two-axis micro-scanner;

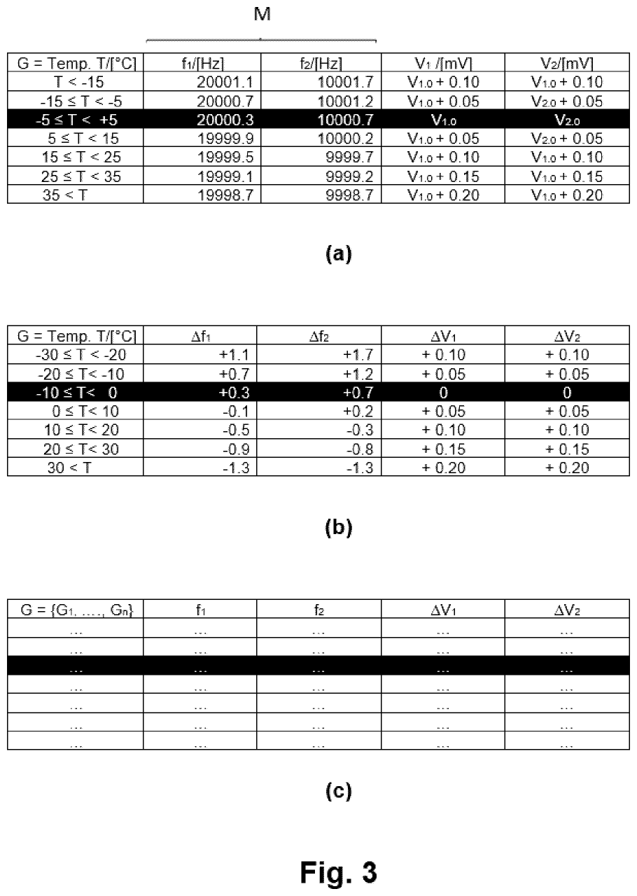

FIG. 3 shows various exemplary tabular representations of a respective discrete set of frequency and amplitude pairs;

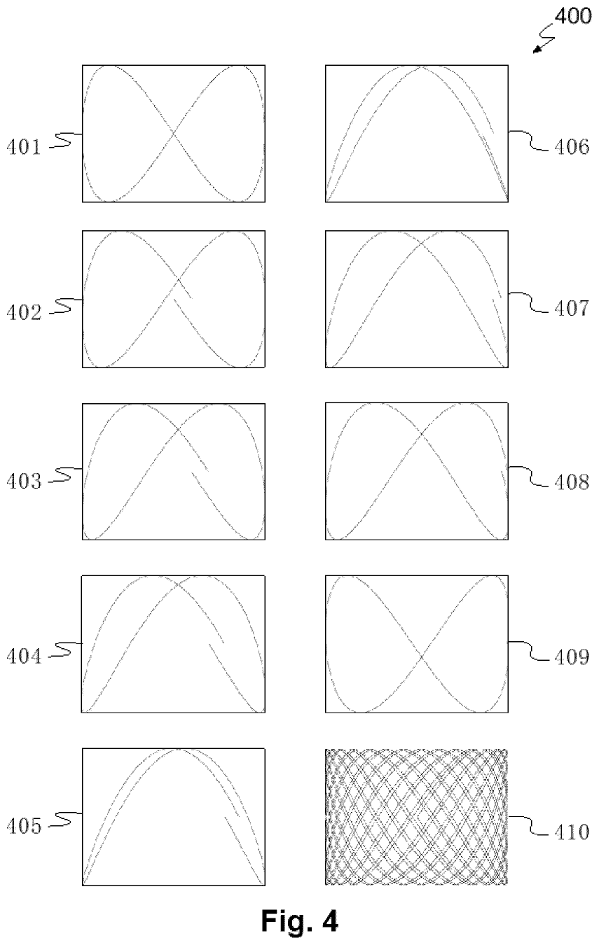

FIG. 4 shows, by way of example, (i) a closed initial trajectory, (ii) a series of trajectory sections for successive phase runs of a controlled trajectory, and (iii) the controlled trajectory resulting from the juxtaposition of these trajectory sections, each in a Lissajous projection by means of an exemplary micro-scanner system according to the solution with a two-axis micro-scanner onto a projection surface in an observation field to be illuminated;

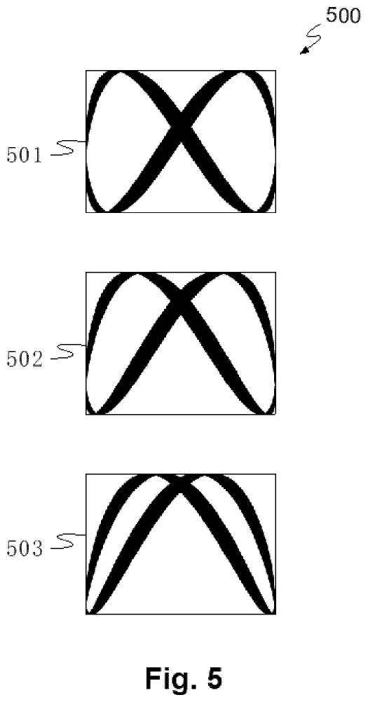

FIG. 5 shows three exemplary temporally successive partial images of a controlled trajectory with only a very small frequency deviation in a Lissajous projection by means of an exemplary micro-scanner system according to the solution with a two-axis micro-scanner on a projection surface in an observation field to be illuminated;

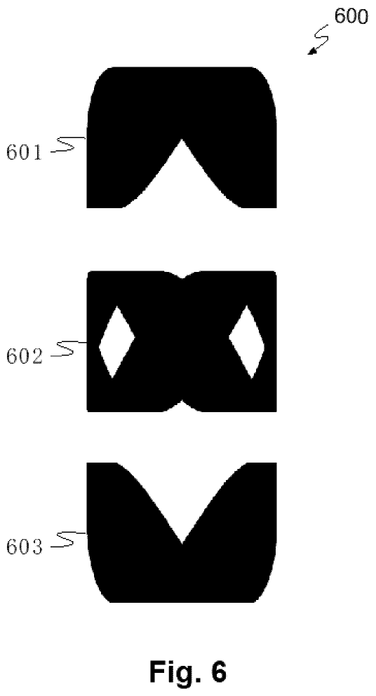

FIG. 6 shows three exemplary temporally successive partial images of a controlled trajectory with a frequency deviation optimized with respect to FIG. 5 in a Lissajous projection by means of an exemplary micro-scanner system according to the solution with a two-axis micro-scanner on a projection surface in an observation field to be illuminated;

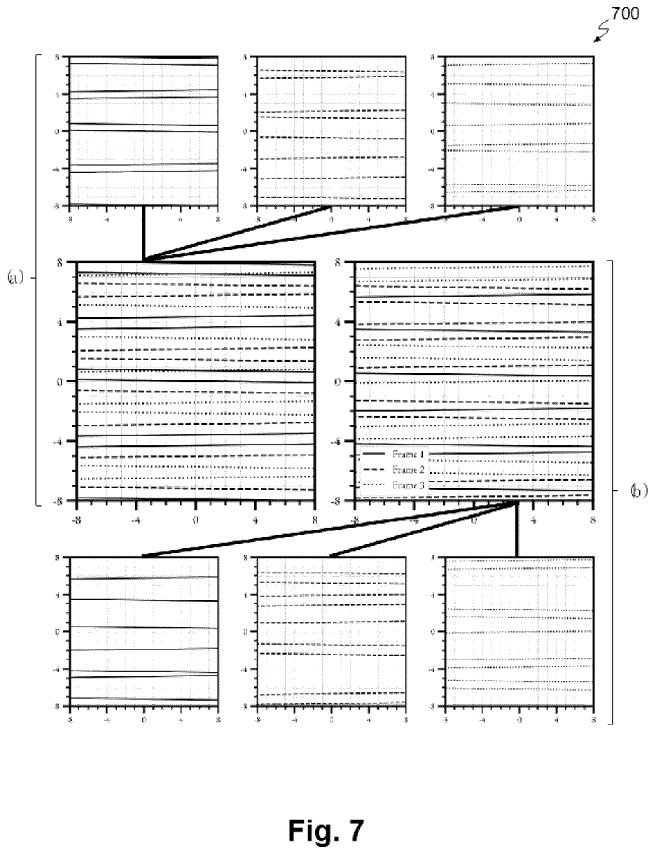

FIG. 7 shows, by way of example, a respective series of trajectory sections for successive phase runs of a controlled trajectory, and the controlled trajectory resulting from the juxtaposition of these trajectory sections, each in a Lissajous projection by means of an exemplary micro-scanner system according to the solution with a two-axis micro-scanner onto a projection surface in an observation field to be illuminated;

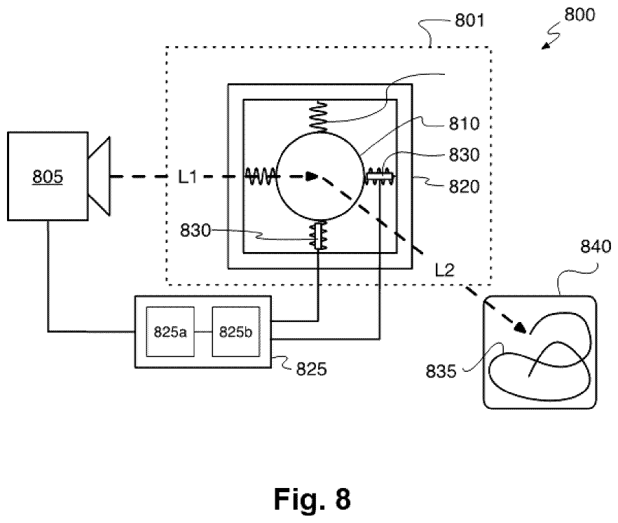

FIG. 8 schematically shows an exemplary beam deflection system according to exemplary embodiments of the solution;

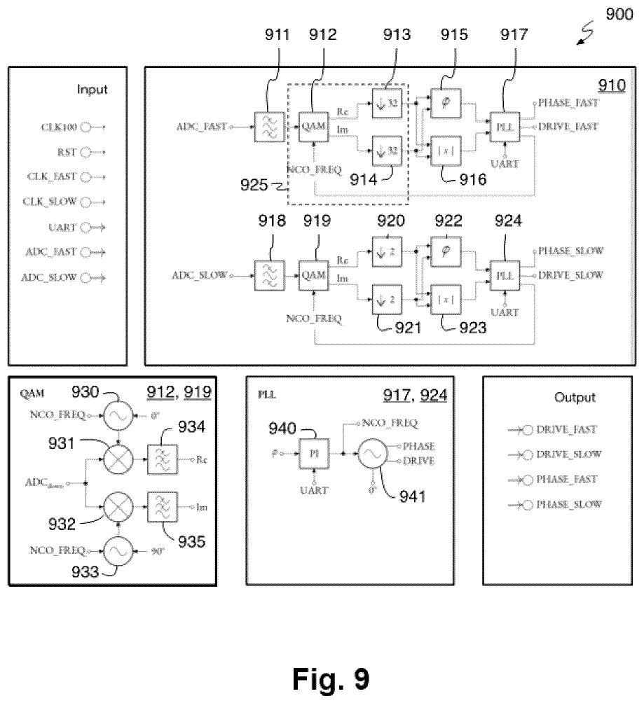

FIG. 9 shows an exemplary block diagram of a circuit for generating control signals for a drive device of a Lissajous micro-scanner without trajectory regulation according to the solution; and

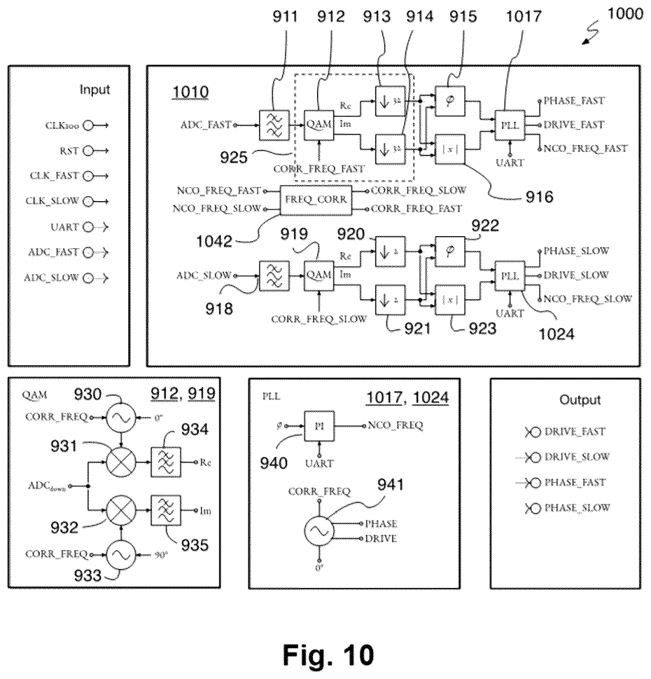

FIGS. 10A/10B show an exemplary block diagram based on FIG. 9 of a circuit for generating control signals for a drive device of an exemplary Lissajous micro-scanner system with a trajectory regulation according to the solution.

In the following, unless otherwise stated, a micro-scanner system with a two-axis micro-scanner is used as an example, without this being understood as a restriction of the present invention to such specific micro-scanner systems.

Laser projection systems based on Lissajous micro-scanners usually function in such a way that an intensity and/or color-modulated laser projects light onto a deflection element of a multi-axis micro-scanner system, particularly in the case of a multi-axis micro-scanner onto a deflection element (mirror) of the same that is suspended in a two-axis manner. The deflection element is or, in the case of several micro-scanners, the deflection elements are in turn driven via a suitable drive device, which can in particular have one or more piezo actuators. This causes the deflection element or elements to oscillate on both axes in such a way that the figure projected by it or them appears to a human observer like an illuminated surface, in particular a rectangular one.

However, the trajectory that the laser point follows actually corresponds to a Lissajous figure, which is only made so complex by the ratio of the oscillation frequencies of the two axes that an observer can ideally no longer distinguish the individual lines. In known solutions with a single two-axis micro-scanner as a micro-scanner system, the oscillation frequencies typically correspond to the corresponding resonance frequencies, namely the natural frequencies, of the suspended mirror (oscillatory system) with respect to the respective oscillation axis, since in such an operation, referred to as “double resonance”, the largest deflections and thus the largest illumination or image area can be achieved.

However, if the drive frequencies are oriented to these resonance frequencies by controlling the respective phase of the oscillations with a phase-locked loop in order to maintain stable resonant, in particular double-resonant, operation, the projected trajectory changes continuously over time, since in most applications the resonance frequency of the system can change over time, in particular depending on the temperature. However, a slight deviation on one or the other axis in frequency or phase can massively influence the trajectory, as the following exemplary trajectories generated by simulation in FIG. 1A show. The lines correspond to the path of the laser spot on a rectangular projection surface to be illuminated, which is perpendicular to the optical axis of the image. The calculation period is respectively ( 1/60) s, i.e. approx. 16.66 ms (this corresponds exactly to one image (frame) to be projected at a typical refresh rate of 60 Hz).

FIG. 1A (a) shows a first example of the calculated trajectory 100 at oscillation or drive frequencies f₁ and f₂ for the two orthogonal oscillation axes of f₁=26314 Hz and f₂=557 Hz. In a second example shown in FIG. 1A (b), the oscillation or drive frequencies are f₁=26314 Hz and f₂=557.1 Hz, i.e. the frequency f₂ of the second axis is detuned by 0.1 Hz compared to the first example. The dimensions of the projection surface or the Lissajous figure on it corresponding to the two axes are labeled with an underlying pixel grid. For these considerations, a resolution of 1920×1080 pixels, which is typical today, should be used, i.e. with 1920 pixels for the horizontal first axis with the frequency f₁ and with 1080 pixels for the horizontal second axis with the frequency f₂.

In order to make the differences between the two trajectories from FIG. 1A more clearly visible in the following considerations, an enlarged section from the middle of the respective trajectory course from FIG. 1A is shown in FIG. 1B for each trajectory from FIG. 1A. Due to the magnification, it is clearly visible that a shift of the drive frequency on the second axis by only 0.1 Hz has a strong influence on the line density. While the trajectory in FIG. 1B (b) is not homogeneous but at least approximately distributed over the entire image area, the left trajectory in FIG. 1B (a) is obviously extremely unfavorable for an image projection, since it does not reach a high number of whole rows of pixels at all.

If, as described above, the drive frequencies on both axes always follow the continuously changing resonance frequencies without regard to the other axis, the projected Lissajous trajectory is not constant over time, but changes depending on the current resonance frequencies, which can be particularly temperature-dependent. For example, the above detuning of the second axis by 0.1 Hz corresponds to such a shift of the corresponding resonance frequency of this axis. Thus, as time progresses, almost any trajectory can be established due to the temporal change in the resonance frequency of one or both axes—including those in which, as shown in FIG. 1B (a) as an example, the individual lines become clearly visible to the observer and large parts of the image to be projected remain unilluminated.

Thus, the temporal course of such a Lissajous trajectory is left to chance to a certain extent, since it depends on the temporally variable ratio of the resonance frequencies of both axes and the line density can therefore be subject to strong temporal fluctuations, which the observer can sometimes perceive even with the naked eye.

Lissajous trajectories can be described mathematically by representing the oscillation frequencies f₁ or. f₂ of the two axes as the product of an integer factor n₁ or n₂ and a repetition rate fᵣₑₛ of the trajectory (trajectory repetition rate):

f₁=n₁·fᵣₑₛ or f₂=n₂·fᵣₑₛ (1)

If the oscillation frequencies are to be resolved in this way and the two integer factors n₁ and n₂ are coprimes, a stable trajectory is formed, which exactly reproduces after the time Tᵣₑₛ (duration of a phase pass)

$${T}_{res} = \frac{1}{{f}_{res}} \qquad ( 2 )$$

It therefore always travels the same path within each period Tᵣₑₛ and is always at the same point after this time. For purely mathematical reasons, however, not all conceivable pairs of oscillation frequencies can be represented in this way, but only those frequency pairs where the ratio of the two frequencies of the frequency pair is a rational number, i.e. where:

f₁/f₂=n₁/n₂ (3)

Other frequency pairs differ from a nearest frequency pair to a stable trajectory by a respective difference frequency Δf on one and/or the other axis. Such trajectories deviating from stable trajectories then leave the optical impression that they initially approximately replicate the trajectory of the stable case closest to them, but then move (“wander”) with a certain speed depending on Δf. The trajectory thus runs in its m-th trajectory section arising during an arbitrary m-th phase pass with a greater or lesser offset than the (m+1)-th trajectory section arising during the immediately following (m+1)-th phase pass, depending on the value of Δf.

Against this background, FIGS. 1A and 1B are to be interpreted in such a way that case (a) forms a trajectory that, due to the two oscillation frequencies, is very close to a stable trajectory with a high repetition rate fᵣₑₛ, so that each pass of the trajectory almost corresponds to the previous one and the individual lines—as can be seen in FIG. 1B (a)—almost coincide. Therefore, such a trajectory omits a large proportion of pixels. Case (b), on the other hand, provides a trajectory that “wanders” more strongly from image to image, wherein a more uniform illumination is achieved in the considered period of approximately 16.6 ms, which corresponds to a phase transition and here also to the duration of a single image, which, however, can also shift towards less favorable illumination in subsequent periods or images.

Another problem with conventional solutions occurs when the frame rate differs from the trajectory refresh rate fᵣₑₛ. This case will now be explained with reference to FIG. 1C, again assuming an image material with a refresh rate of 60 Hz as an example.

FIG. 1C shows in its sub-figures (a) and (b) in a corresponding manner as in FIG. 1B two sections of exemplary stable Lissajous trajectories (a complete phase run) for a time period with the duration of three consecutive images, i.e. frames, of the image material. The three frames 1, 2 and 3 are shown with different line types. In the case of FIG. 1C (a), the drive frequencies corresponding to the resonance frequencies as a result of the respective axis-related phase regulation have the following values: f₁=26314 Hz and f₂=557.5 Hz, which according to the above relation (1) follows a trajectory repetition rate with the value fᵣₑₛ=111.5 Hz with n₁=256 and n₂=5. In the case of FIG. 1C (b), however, the resonance frequencies and drive frequencies have the following values: f₁=26314.753 Hz and f₂=557.194 Hz, which results in a significantly lower trajectory repetition rate fᵣₑₛ=25.327 Hz with n₁=1039 and n₂=22 compared to the case of FIG. 1C (a), so that n₁ and n₂ are coprimes.

In the case of FIG. 1C (a), the trajectory omits essential image content during its complete phase pass due to its high repetition rate, so that only a part of the first frame and neither the second nor the third frame are displayed in the projection during the observation period. In the opposite case of FIG. 1C (b), however, the trajectory repetition rate is so low that within the duration of a frame (e.g., frame 1), some lines are not even sampled at all. Consequently, for example, the lowest displayed line is only reached starting from the second frame (frame 2).

For this reason, previously known approaches that address trajectory density mostly aim at projecting stable Lissajous trajectories the trajectory refresh rate of which is approximately in the range of the refresh rate of the image material to be projected. This means that only a comparatively small range of values for the trajectory repetition rate fᵣₑₛ is permitted and only a very limited range of pairs of drive frequencies is possible. In addition, since stable trajectories inevitably always omit the same image content, even in this supposedly ideal case of those trajectories that repeat at about the frame rate of the image material, unlit image content that is recognizable to the viewer can occur if the resonance frequencies of the micro-scanner system are not already designed so high during the manufacturing process that the resulting trajectory can reach all pixels within one phase pass.

Referring to FIG. 2, an exemplary embodiment 200 of a method according to the invention for trajectory regulation of a micro-scanner system with a two-axis micro-scanner is now explained. The method 200 is described starting from a resting state of the micro-scanner. First, the operation of the micro-scanner is started, resulting in a transient process in which the oscillation amplitude increases up to a maximum (“oscillation swing in”).

The oscillation movements of the oscillating part of the micro-scanner, i.e. in particular the deflection element (mirror) including its suspension, are driven by means of a suitable drive device, which can in particular have one or more piezo actuators, such that as a result of the oscillation a biaxial double-resonant oscillation occurs with respect to a first and a second oscillation axis of the deflection element that is orthogonal thereto. During the oscillation, the micro-scanner is operated in such a way that it oscillates with the corresponding current resonance frequency with respect to each of the two axes, at least at the end of the oscillation process. This can be done in particular by means of a conventional phase regulation (still without additional trajectory regulation) per axis, as will be explained below with reference to FIGS. 9 and 10. When a laser beam is projected onto the oscillating deflection element and reflected there, a closed, stable trajectory is created in the observation field. A simple example of such a stable trajectory can be seen in FIG. 4 in image 401.

During the swinging in or when the transient process has already been completed and a stable trajectory is present, a measurement of at least one physical variable G is carried out in a step 210, which is dependent on the resonance frequencies of the micro-scanner for the two current axes at that time. In particular, the dependence may be such that (i) the physical variable G depends on the resonance frequencies, (ii) conversely the resonance frequencies depend on the physical variable G, or (iii) there is a mutual dependence. Ideally, the dependency corresponds to a mathematical function. What is crucial is that the resonance frequencies can be determined from the measured value of G. In the case of several measured physical variables (number n), these can be combined into a multidimensional variable G, in particular as a set of values or vector G={G₁, . . . , Gₙ}.

Now, in a step 215, a frequency pair for the drive frequencies for the two axes for a subsequent time interval can be determined as a function of G according to a predetermined selection rule. This can be done, for example, by selecting from a discrete set of frequency pairs stored, for example, in a storage device, or directly during the course of the method by determining, in particular calculating, such a frequency pair in accordance with the selection rule, which in this case can in particular contain a corresponding calculation rule.

For a more detailed explanation of step 215, reference is now made to FIG. 3. There, one such selection rule according to step 215 is illustrated by way of example using three value tables which—as explained—can either already be kept or implemented in the sense of a calculation rule. In this example, for the first two tables in FIGS. 3 (a) and (b), a temperature of the micro-scanner, which can be determined in particular without contact, for example by means of infrared measurement or via an NTC measuring element in or on the micro-scanner, is used as the scalar physical variable G. The respective table assigns to each value of G a corresponding frequency pair {f₁; f₂}. To illustrate this, one row of each table is shown in inverted color. If the temperature given by the value of the variable G is, for example, −7° C., the frequency pair {f₁; f₂}={20,000.3 Hz; 10,000.7 Hz} is selected according to the selection rule in FIG. 3 (a). In the present example, the closest resonance frequency that can at least theoretically be achieved by the micro-scanner is f_{0,1}=20,000 Hz for the first axis and f_{0,2}=10,000 Hz for the second axis, so that it is always guaranteed that the frequency pair {f₁; f₂} resulting from the table differs from the frequency pair {f_{0,1}; f_{0,2}} of the closest resonance frequencies mentioned with respect to at least one of the two frequencies or axes (i.e. f₁ #f_{0,1} and/or f₂ f_{0,2}).

In FIG. 3 (b) the same selection rule is shown again, but in a different and particularly suitable form with regard to the desired systematic deviation of the frequency pair to be selected from the frequency pair {f_{0,1}; f_{0,2}}. Instead of directly specifying the frequency values for the frequency pair to be selected, the frequency values are given here indirectly through the corresponding frequency deviations from the frequency pair {f_{0,1}; f_{0,2}}. Accordingly, the frequency deviations from the table in FIG. 3 (b) are Δf₁=+0.3 Hz and Δf₂=+0.7 Hz, respectively. If the resonance frequencies {f_{0,1}; f_{0,2}} are known, the two representations are equivalent and both define the same selection rule and thus for each selection process also the selected frequency pair {f₁; f₂}.

In FIG. 3 (c) the case is illustrated where instead of a single physical variable a set of several different physical variables is measured and the frequency pair to be selected is determined depending on this set of variables G={G₁, . . . , Gₙ}. A specific frequency pair is selected here if the measured set G of variables falls into a spatial region associated with the frequency pair in the multidimensional (mathematical) space spanned by the individual variables G₁, . . . , Gₙ (if G is considered as a vector, then the space can be considered as an n-dimensional vector space). In addition to or instead of temperature, such physical variables may in particular be a mechanical stress or strain, an oscillation amplitude or a phase instability of the micro-scanner occurring in at least one of the oscillations. In addition or instead, one or more of the following variables can also be used: an exceeding of the control variable of the trajectory regulation according to the method; a phase difference between a drive signal for controlling the drive device and a measurement signal that represents a measured deflection of the deflection element; a shift in the respective axis-related resonance frequency; a change in the radiated electromagnetic radiation power that the deflection element absorbs; a change in the amplitude, frequency or phase of a reference oscillator for the oscillation of the deflection element.

In addition to the respective discrete set M of frequency pairs, the three tables in FIG. 3 also contain an associated set of discrete amplitude pairs {V₁; V₂} or {ΔV₁; ΔV₂}, which represent in the form of voltage amplitudes for controlling the drive device as amplitude values or amplitude deviation values with respect to reference amplitudes, which can in particular correspond to the oscillation amplitudes in the double-resonant case, a possible amplitude regulation possible in addition to the frequency control within the framework of the trajectory regulation of the method. As with the frequency pairs, mixed forms are also possible with regard to the amplitude pairs or overall, in which on the one hand absolute frequency or amplitude values, but on the other hand also corresponding deviation values with regard to corresponding reference values are specified within the framework of the selection rule.

Referring again to FIG. 2, step 215 is followed by a further step 220 in which it is checked whether the frequency pair selected according to step 215 corresponds to the frequency pair already currently valid, i.e. whether no frequency adjustment is required or already is. If the two frequency pairs match (220—yes), the method branches back to step 210 for a new pass. Otherwise (220—no), in a step 225, the drive frequencies for the drive device of the micro-scanner are changed to the new frequency pair selected in step 215 and, if applicable, the new amplitude pair, which determines a corresponding amplitude gain or reduction (=negative amplitude gain). Such a change is equivalent to the beginning of a new time interval, since here the term “time interval” corresponds to a specific frequency pair or the period of time between two consecutive frequency pair changes during which the specific frequency pair is used to drive the micro-scanner.

Subsequently, the process branches back to step 210 for another process run. The steps 210 to 225 represent overall a trajectory regulation 230, which is provided in addition to a pure phase regulation that may be present, by means of which the course of the trajectory resulting from the operation of the micro-scanner or a beam deflection system based thereon (cf. FIG. 8) is controlled as a function of the at least one physical variable G and thus of the temporal course of the current resonance frequencies. In particular, with a suitable definition of the frequency pairs and the selection rule, a trajectory density regulation can be carried out, which can provide a largely homogeneous illumination of the observation field and thus a correspondingly high image quality of the images projected into the observation field.

FIG. 4 illustrates an exemplary sequence 400 of trajectory sections 401 to 409 that can be generated when applying the method for trajectory regulation, in particular according to FIG. 2, which sections each correspond to a complete phase run of the trajectory. The following FIG. 410 shows the controlled trajectory resulting from the juxtaposition of these trajectory sections 401 to 409. All representations in FIG. 4 are the result of a Lissajous projection using a micro-scanner onto a projection surface in an observation field to be illuminated (cf. FIG. 8). In the following, without this being understood as a limitation, for the purpose of better explanation, specific reference is made to the embodiment 200 of the method according to FIG. 2.

The image 401 represents a stable trajectory, as can occur in particular at the end of the oscillation process according to step 205 of method 200. Such a Lissajous trajectory is projected, for example, by a mirror with (current) resonance frequencies of f_{0,1}=10 kHz and f_{0,2}=20 kHz. The underlying parameters of the trajectory can then be calculated, according to the known oscillation equations for Lissajous trajectories

x₁(t)=sin(2πn₁fᵣₑₛ·t) (4a)

x₂(t)=sin(2πn₂·tfᵣₑₛ) (4b)

as follows:

f₁=f_{0,1}=10 kHz,f₂=f_{0,2}=20 KHz⇒n₁=1,n₂=2,fᵣₑₛ=10 KHz (5)

Essentially, the parameters n₁ and n₂ then describe the nodes and thus the line density of the trajectory and the frequency fᵣₑₛ—or more precisely: its reciprocal

$${T}_{res} = \frac{1}{{f}_{res}} = 0 , 1 ms -$$

the duration after which the path of the trajectory has been completely traversed once (phase pass). A micro-scanner with a ratio of the resonance frequencies of f_{0,1}:f_{0,2}=n₁:n₂=1:2 permanently projects the stable trajectory shown in FIG. 401, provided that this ratio is exactly matched by the drive frequency pair {f₁; f₂} and the resonance frequencies remain constant over time.

However, if a time-dependent detuning of the resonance frequencies occurs, for example due to a temperature change of the micro-scanner, then the frequency control 230 can, depending on the applicable selection rule, cause a different frequency pair {f₁; f₂} from the discrete set M (cf. FIG. 3) to define the drive frequencies for driving the micro-scanner by means of the drive device, instead of the original frequency pair corresponding to the original resonance frequency values. According to the definition of the set M, this new frequency pair deviates from a current resonance frequency at least with respect to one of its two frequencies, ie: f₁≠f_{0,1} and/or f₂≠f_{0,2}.

The stable trajectory shown in FIG. 401 obviously leaves most of the image unilluminated, so that the frequency shift n₁ and n₂ must be increased to such an extent that, in the case of the projection of a digital two-dimensional image, all pixels of the image are reached in a then also changed time period

$${T}_{res}^{′} .$$

### Ideally,

$${T}_{res}^{′}$$

is less than the appearance duration of an image, which for common video formats is less than about

$$\frac{1}{30} s or \frac{1}{60} s .$$

Since this cannot usually be achieved in practice, trajectories are usually produced whose period duration is considerably longer, but which nevertheless reach the maximum possible number of pixels for these respective partial images and also do not omit the same pixels in successive images, so that the impression of an at least largely homogeneously illuminated projected image is nevertheless created over several phase runs.

Accordingly, in FIG. 4, images 402 to 409 show eight consecutive, respectively complete phase passes to the new “shifted” frequency pair {f₁; f₂} which, starting from {f_{0,1}; f_{0,2}}, is defined by the frequency deviations Δf₁=312.5 Hz at a constant drive frequency of the second axis (Δf₂=0 Hz). This, with the resulting new drive frequency f₁=10,312.5 Hz, results in images 402 to 409 in FIG. 4.

The trajectory is now no longer stable, but changes from phase to phase, so that the trajectory as a whole changes its shape over the period under consideration and thus appears to wander, so that the trajectory density (line density) increases. The frequency pair {f₁; f₂} is defined in such a way that the trajectory during its next pass is placed in particular in those image areas that were not reached in the previous pass. Over the entire observation period corresponding to images 401 to 490, the trajectory course shown in image 410 results, which provides an almost homogeneous illumination of the rectangular projection surface in the observation field and thus an appealing image quality if the trajectory repetition rate, as mentioned above, is so high that the observer cannot recognize the individual images separately from one another.

The trajectories were thus “pushed” into the previously omitted areas, making the newly created trajectory much more suitable for image projection. The optimal frequency deviations, which determine the degree of shift of the trajectories, obviously depend on the proportion of omitted area in the original trajectory. In principle, the frequency can be changed on both axes or on both axes at the same time.

The example just illustrated in FIG. 4 is striking because the frequency deviation is very high at Δf₁=312.5 Hz. This would shift the drive frequency very far away from the resonance frequency of this axis, which would mean that it would no longer be possible to project an image, especially with mirrors with high quality factors (Q factors), since the amplitude on this axis would collapse significantly or even completely. The size of the frequency deviation is therefore based on the goal of maximizing the trajectory density or (here synonymous) the line density, but on the other hand not to reduce the extent or size of the projected image to an unacceptable level, in particular not in such a way that the position of the pixels changes. However, in individual cases, depending on the application, a reduction in the image size is acceptable within certain limits, especially if only a section of the image (in the sense of a “region of interest”) is important.

However, if or to the extent that a certain image extension is to or must be maintained, the maximum frequency shift within the framework of the trajectory regulation (cf. FIG. 2, trajectory regulation 230) is determined by the extent to which the extension reduction caused thereby (alone) can be compensated by a counteracting amplitude control (in particular amplitude amplification).

Comparing the above example from FIG. 4 with another example in which a frequency deviation of only Δf₁=1 Hz is chosen, this requirement is easy to achieve here, especially with the aid of a compensating amplitude control. However, the shift of the trajectory from phase pass to phase pass is thus relatively smaller, so that individual, successive phase passes (with the original running period Tᵣₑₛ=0.1 ms)) can then no longer be distinguished from one another by an observer with the naked eye.

Therefore, for this example, it is more illustrative, as shown in FIG. 5, to map the trajectory 500 for discrete time periods that roughly correspond to human perception and common frame rates. This duration should be assumed here as

$$\frac{1}{30} s .$$

In FIG. 3, the respective trajectory sections that occur during three such consecutive time periods are illustrated in the representations 501 to 503 of the image area to be illuminated.

Here a phenomenon is visible that can often be observed in practice. Rarely does a long-term stable trajectory like that in FIG. 401 actually occur. Rather, the observer gets the optical impression that such a trajectory is gradually rotating. The frequency deviation should therefore ideally be chosen such that a human observer with the naked eye cannot perceive the trajectory as such, neither as completely static nor as moving. This trajectory 500 is also characterized by the fact that it appears to have represented only after a large number of the above periods of time all image areas and thus, in the case of a two-dimensional digital image, all pixels.

Although the example given here with resonance frequencies of f_{0,1}=10 kHz and f_{0,2}=20 kHz represents an unfavorable starting point, by sufficient shifting on both axes a case can still be constructed that meets typical requirements for homogeneity and extension preservation of the illumination or at least comes close to them, depending on the level of requirement. With Δf₁=3.92 Hz and Δf₂=−1.92 Hz, the three trajectory sections illustrated in FIG. 6 in the representations 601 to 603 of the rectangular image area to be illuminated are projected in three consecutive time intervals of

$$\frac{1}{30} s$$

duration each, which together complement each other to form an essentially complete illumination 600 of the image area. This means that in the case of a digital image, all pixels are reached at least after three consecutive time intervals, wherein almost all pixels have been displayed, i.e. projected, after just two intervals, and thus this projection is favorable for these resonance frequencies.

A) In order to determine a suitable set of frequency pairs for the discrete set M, a first embodiment is particularly suitable in this respect, in which a maximum line spacing between adjacent line courses of the trajectory is assumed in order to determine the set of frequency pairs.

This embodiment is particularly advantageous in connection with Lissajous projections when frequency pairs are defined whose associated trajectory repetition rates are (in particular significantly) below the refresh rate of the image material to be projected (e.g. video). For example, for a refresh rate of 30 Hz, frequency pairs could be defined whose corresponding trajectory refresh rates are in the range of 5 Hz to 15 Hz. One can then assume a priori that such trajectories change from image to image, i.e. for observation periods of

$$\frac{1}{30} s .$$

The line spacings of adjacent trajectory sections of a Lissajous figure are usually larger on average in the middle of the Lissajous figure than at its edge. The maximum line spacing dₘₐₓ also typically occurs in or near the center of the Lissajous figure. The following relationships apply to dₘₐₓ, wherein the index “1” refers to a distance with respect to the image extension caused by the first oscillation axis and the index “2” refers to a distance with respect to the image extension caused by the second oscillation axis:

$$2 \cdot {d}_{1 , max} = sin ( \frac{π}{{n}_{2}} ) \qquad ( 6 a )$$

$$2 \cdot {d}_{2 , max} = sin ( \frac{π}{{n}_{1}} ) \qquad ( 6 b )$$

Using these distances, one can now determine target values for the factors n₁ and n₂ already known from relation (1) if the maximum line distances d_{1,max} and d_{2,max} are specified. For example, in the case of a Full HD resolution with 1920 pixels in the horizontal image direction and 1080 pixels in the vertical image direction, one can specify that the maximum line spacing in each of these directions should correspond to one pixel. If one normalizes the image height and width to the value 1, it follows:

$${d}_{y , max} = \frac{1}{1080} and {d}_{x , max} = \frac{1}{1920} . \qquad ( 7 )$$

From the relationships (6a) and (6b) the following lower thresholds for the values of n₁ and n₂, which are each natural numbers, are obtained:

nₓ≥1696 and n_{y}≥3016. (8)

By complying with these thresholds, one can now identify pairs of values (n₁; n₂)) that simultaneously satisfy the criterion of coprimeness of n₁ and n₂. Preferably, in this way, a discrete, limited and finite set of value pairs (n₁; n₂) or, according to the relationships (1) and (3), corresponding frequency pairs (f₁; f₂) are searched for and determined, which are as close as possible to these thresholds from relationship (8), since otherwise the trajectory pass time becomes very long and in particular can approach or even exceed the frame rate.

In particular, considering a micro-scanner system that provides at least an approximate raster scan setup of the projected trajectory, only criterion (6b) for d_{2,max} needs to be fulfilled, since the lines of the trajectory run approximately horizontally and then still hit all pixels. This will now be illustrated using the example of a micro-scanner system with resonance frequencies of approximately f_{0,1}=18418 Hz, f_{0,2}=631 Hz.

Dividing the resonance frequency f_{0,1} of the fast axis by the factor of 1696 according to equation (1) results in approximately fᵣₑₛ=10.86 Hz. One can now, according to the procedure described above, determine frequency pairs (f₁; f₂) for the set M which form trajectories that are as close as possible to this trajectory repetition rate fᵣₑₛ, i.e. which satisfy the coprimality for the two factors n₁ and 2, and which, with this trajectory repetition rate fᵣₑₛ, land on both axes approximately at the mentioned resonance frequencies f_{0,1} and f_{0,2} respectively. For these trajectories, depending on the choice of the frequency pair (f₁; f₂), the image is constructed somewhat slower than for an “ideal” trajectory with the trajectory repetition rate fᵣₑₛ or not every pixel is hit anymore, but a good approximation to the ideal trajectory is obtained.

B) In order to determine a suitable set of frequency pairs for the discrete set M, a second embodiment is also suitable in this respect, in which, starting from one or more resonance frequency pairs {f_{0,1}, f_{0,2}} potentially possible for the specific micro-scanner with respective associated trajectory repetition rates fᵣₑₛ, which correspond to perfectly stable and thus closed trajectories (cf. image 401 in FIG. 4), one or more of the frequency pairs of the set M to be determined, which are shifted relative thereto, are determined according to the following relationships:

$${f}_{1} = {f}_{0 , 1} + Δ {f}_{1} with Δ {f}_{1} = \frac{1}{{n}_{Δ} \cdot {n}_{2}} \cdot {f}_{res} \qquad ( 5 a )$$

$${f}_{2} = {f}_{0 , 2} + Δ {f}_{2} with Δ {f}_{2} = \frac{1}{{n}_{Δ} \cdot {n}_{1}} \cdot {f}_{res} \qquad ( 5 b )$$

wherein n_{Δ}∈ [symbol] with |n_{Δ}|>0, preferably with |n_{Δ}|>1, applies and n₁, n₂≥1 are each integers and coprimes, so that:

f_{0,1}=n₁·fᵣₑₛ and f_{0,2}=n₂·fᵣₑₛ. (6)

It should be noted that the frequency deviations Δf₁ and Δf₂ in the relationships (5a) and (5b) refer to the theoretically assumed ideal trajectories for the respective resonance frequency pair {f_{0,1},f_{0,2}} serving as the starting point of the calculation, while the actual resonance frequencies currently present may deviate therefrom. The frequency deviations Δf₁ and Δf₂ in the relationships (5a) and (5b) must therefore be distinguished from the differential frequencies occurring in the actual procedural operation of the micro-scanner between the respective drive frequencies and the associated actual current resonance frequencies for the same axis.

The higher the value of n_{Δ} and thus the lower the values of Δf₁ and Δf₂ are chosen, the smaller the shift from phase pass to phase pass is—and therefore, in the case of trajectories with an already very high line density, small shifts are sufficient to at least largely fill in the current phase pass the image parts that were left out in the previous phase pass. Therefore, such a discrete set M with respective trajectories corresponding to their frequency pairs can be determined by choosing different values for n_{Δ}, for each of which trajectories are formed that continuously shift into image regions omitted for the originally assumed double-resonant trajectories for the respective frequency pair {f_{0,1},f_{0,2}}.

This also applies, and in particular, to the trajectory that would occur at the actual resonance frequencies. In a sense, it is automatically guaranteed that the trajectory that forms at the current resonance frequencies will shift into the image parts that it has omitted if it is moved towards trajectories for which it is a priori guaranteed that it will repeatedly shift into previously unreached image areas within predetermined time periods. To ensure this, the approach presented is only one possible.

By a clever combination of the set M and thus the desired trajectories, it can be ensured that the frequency pairs of the set M and thus their associated trajectories fulfill the above-mentioned condition of not deviating greatly from the resonance frequencies and thus producing a stable image. Therefore, it can be particularly advantageous not only to combine the desired trajectories according to the relations (5a), (5b) and (6), but to determine as broad a spectrum of trajectories as possible that continuously shift into initially omitted image areas.

In particular, the values for the parameter ng can be chosen such that |n_{Δ}|∈{2, 3, 4, . . . } is valid, with smaller values being preferred. In the special case of n_{Δ}=2, which is illustrated in FIG. 7, as shown by the illumination 700 of the image area, in each phase pass, the pixels tend to be reached that were not yet reached in the previous phase pass. If one looks at the respective trajectory sections of two directly successive phase passes, one can see that the lines of the second phase pass are positioned between those of the first.

As will be shown in detail below, two frequency pairs can be determined with f₁=26314.5806 Hz and f₂=557.2761 Hz for the example from FIG. 7(a) or with f₁=26314.2620 Hz and f₂=558.6104 Hz for the example from FIG. 7(b), which, with regard to good comparability with regard to their phase pass times Tᵣₑₛ or corresponding trajectory repetition rates, are respectively close to those of the trajectories already shown in FIGS. 1A to 1C. The trajectory in FIG. 7 (a) is based on a trajectory repetition rate fᵣₑₛ of approximately 111 Hz, whereas that in FIG. 7 (b) is based on a trajectory repetition rate of approximately 29 Hz. They are again examined at a frame rate of the underlying image material with a refresh rate of 60 Hz.

From FIG. 7 it is immediately apparent that the continuous shift of the trajectory over time ensures that from frame to frame of the image the parts of the image that were previously omitted tend to be reached. After a period of time corresponding to 3 displayed images, no larger image content remains unreached. The trajectory course was determined here by the special choice n_{Δ}=2 such that the trajectory resulting after the frequency adjustment carried out as part of the trajectory regulation 230 differs from the original trajectory from FIG. 1A (a) or FIG. 1B (a) in such a way that the lines of the second phase pass tend to lie. exactly between those of the first phase pass and those of the third phase pass between those of the second.

For the example in FIG. 7(a), a trajectory repetition rate of fᵣₑₛ=111,50246 Hz is assumed. This results in f₁=236·111,5025 Hz=26314,5806 Hz and f₂=5·111,5025 Hz=557,5123 Hz. If one were to choose this frequency pair as the driving frequency pair, however, an (undesirable) picture of a stable trajectory would result in which the differently highlighted lines from FIG. 7(a) would coincide as in FIG. 1C (a). Instead, however, the frequency f₂ was modified by a frequency deviation

$$Δ {f}_{2} = \frac{1}{2 {n}_{1}} \cdot {f}_{res} = \frac{1}{2 \cdot 236} \cdot 111 , 5025 Hz = 0 , 2362 Hz ,$$

resulting in the actual drive frequency f₂=(557,5123−0,2362) Hz=557,2761 Hz, which leads to the trajectory shown in FIG. 7(a). In order to achieve an optimized trajectory, it is irrelevant whether Δf₂ is added or subtracted according to different variants—and also whether the value of

$$Δ {f}_{1} = \frac{1}{2 {n}_{2}} \cdot {f}_{res} = \frac{1}{2 \cdot 5} \cdot 111 , 50246 Hz = 11 , 1502 Hz$$

is added or subtracted instead of or in addition to f₁.

For the further example in FIG. 7(a), a trajectory repetition rate of fᵣₑₛ=29.40141 Hz is assumed. This provides f₁=895·29.40141 Hz=26314.2620 Hz and f₂=5·29.40141 Hz=558.6268 Hz. If one now modifies the frequency f₂ by a frequency deviation

$${Δ}_{2} = \frac{1}{2 {n}_{1}} \cdot {f}_{res} = \frac{1}{2 \cdot 895} \cdot 29.40141 Hz = 0.0164 Hz ,$$

the optimized drive frequency f₂=(558.6268−0.0164) Hz=558.6104 Hz results, which leads to the trajectory shown in FIG. 7(b). Again, according to different variants, Δf₂ can be added to or subtracted from f₂—and/or the value of f₁ can be added to or subtracted from

$$Δ {f}_{1} = \frac{1}{2 {n}_{2}} \cdot {f}_{res} = \frac{1}{2 \cdot 19} \cdot 29.40141 Hz = 0.7737 Hz .$$

The trajectory repetition rates of about 111 Hz and about 29 Hz, as used and shown in FIG. 7 (a) and (b), produce comparably high line densities, so that finally the available range of drive frequencies on both axes can be considerably increased, especially in comparison to projection using stable trajectories. Simulations confirm the impression gained above, that a percentage-calculated illumination—thus in the case of digital images, the number of pixels hit with respect to the number of all pixels of an image with a given resolution—is approximately the same for given time periods of, for example, 1/30 s, regardless of whether the refresh rate d is exactly 30 Hz or alternatively 60, 90 or 120 Hz. This results in significantly greater flexibility and, due to the continuous trajectory shift, a more homogeneously illuminated image compared to the conventional approach.

Using the aforementioned first and/or second embodiment for determining the set of frequency pairs for the discrete set M, a phase-locked loop can be well combined with a trajectory regulation, in particular line density regulation. In particular, this can prevent the requirements of line density regulation from restricting or making phase regulation impossible. In comparison to the conventional, pure phase regulation of the drive signals, not only are both oscillation axes of the micro-scanner controlled independently of each other to resonance, but rather the entire system is regulated according to Lissajous trajectories, which all meet the described requirements to a sufficient extent, in particular approximately equally. This could then also be formulated in such a way that the phase regulation on both axes is discretized by the line density regulation, i.e. with regard to maximum illumination, according to the scheme presented.

The change between frequency pairs, i.e. between respectively assigned time intervals, within the framework of trajectory regulation, ideally occurs when the trajectory is located in an outer image area, since due to the typically high trajectory line density there (cf. FIG. 1A), a change in the shape of the trajectory at this time usually occurs in an invisible manner for the observer.

If the resulting frequency deviation of the drive frequencies from the actual current resonance frequencies becomes so great that a consistently sized image is no longer displayed due to the associated reduction in the oscillation amplitude, either an amplitude control loop can be added that supplies the system with more or less energy (e.g. by adjusting the drive voltage), or the resonator can be detuned on one or both axes, for example by changing the temperature in a targeted manner, so that the resonance frequencies again adjust to the selected drive frequencies.

It is also possible to assume trajectories that have trajectory refresh rates that are relatively wide, but at the same time not too far below 30 Hz, so that they only close over a small number of visible partial images and cannot cover an entire image frame per pass at a 30 Hz refresh rate. The example shown in FIG. 6 was formed exactly according to this scheme. If one therefore shifts the original trajectory from image 401 of FIG. 4 in the direction of this trajectory, it is again guaranteed that the original trajectory shifts into the image parts that it previously omitted.

Overall, the aim here is to move a Lissajous trajectory that omits parts of the image in a particular observation period into precisely these areas in the next observation period. This can be achieved here in particular by ensuring that, in the sense of a positive list determined by the set M, in principle only those trajectories are permitted for which exactly this is known in advance—in particular for relevant viewing periods, which are usually based on human perception and the frame rate of common video formats.

FIG. 8 schematically shows a beam deflection system according to an exemplary embodiment 800 of the present invention, which can be used in particular for projecting images or image sequences (e.g., moving images, videos, etc.). The beam deflection system 800 includes a radiation source 805, which can in particular be a laser source, wherein the wavelength of the emitted radiation L₁ can be in particular in the visible spectral range, although depending on the application, other spectral ranges can also be used, for example in the context of methods for material inspection. In the following, unless otherwise stated, it is assumed by way of example that the radiation L₁ is emitted as a laser beam in the visible spectral range.

The laser beam L₁ is directed at a micro-scanner which has a deflection element 810 in the form of a mirror plate suspended from a surrounding frame 820 via two crossed pairs of springs 815, each of which defines an oscillation axis. At the deflection element 810, the beam L₁ is reflected (mirrored) in the sense of an optical image and directed as a reflected beam L₂ onto a projection surface 840 in the observation field of the micro-scanner.

The beam deflection system 800 furthermore includes a control device 825, which is configured to supply the radiation source with at least one modulation signal, depending on which the laser beam is modulated. The modulation can particularly affect its temporal or local intensity profile. However, depending on the type of radiation source, other types of modulation are also conceivable, in particular modulations of the wavelength (for example color) or wavelength distribution of the radiation emitted by the radiation source 805. When projecting images, the modulation accordingly takes place depending on the current deflection direction, so that corresponding image points on the projection surface having the associated pixel value of the corresponding image point of the image to be displayed are generated by modulation.

The control device 825 is furthermore configured to control a drive device of the micro-scanner in order for it to cause the drive of simultaneous oscillations of the deflection element 810 of the micro-scanner about its two oscillation axes according to the method of FIG. 2, so that the light or radiation point generated by the reflected beam L₂ on the projection surface 840 runs along a trajectory or path in the form of a trajectory-regulated Lissajous FIG. 835, which completely illuminates an area on the projection surface intended as an image surface already within a short time interval. In the case of a projection of a digital image made up of pixels, this means that all pixels are reached or displayed by the trajectory during observation time. The drive device can in particular have at least one actuator, in particular piezo actuator 830. In FIG. 8, two piezo actuators 830 are shown as an example according to a conceivable embodiment, each mounted on one of the springs 815 per spring pair A further such piezo actuator 830 can also be provided on the other two springs 815.

The control device 825 has a phase-locked loop for each oscillation axis for stabilizing a phase difference between a phase of the first or second oscillation corresponding to the oscillation axis and an associated control signal output by the phase-locked loop for the drive device with respect to the oscillation axis. Furthermore, it has a frequency adjustment device for the phase-locked loop in order to detune the oscillation frequency for a respective time interval by adjusting the frequency of the control signal with respect to the oscillation axis by a frequency deviation determined for this time interval according to the method from FIG. 2 (or another embodiment of the method according to the solution).

To carry out the method, the control device 825 can in particular have a data processing device 825a with one or more processors and a storage device 825b. In particular, a computer program can be stored in the storage device 825b, which is configured to cause the control device to execute the method when it runs on the data processing device or its at least one processor. In particular, the frequency adjustment device can be implemented in whole or in part in this form by software. In addition, the storage device can serve to store the predetermined frequency pairs of the set M and, if applicable, the associated amplitude pairs (cf. FIG. 3).

However, the beam deflection system 800 is also operable in the opposite direction, so that radiation emitted or reflected by an object to be observed is scanned by means of a Lissajous figure and in this case reflected on the corresponding oscillating deflection element 810 and imaged in the direction of the unit 805, where a sensor device can then be located, in particular an image sensor, in order to sensor-detect the radiation, in addition or instead of a laser source.

FIG. 9 shows an exemplary control device 900 for trajectory regulation of a micro-scanner in the form of a block diagram of an exemplary circuit for generating control signals for a drive device of a Lissajous micro-scanner, but still without a trajectory regulation according to the solution. In the block diagram of FIG. 9, block 910 represents the actual control device as a block diagram, while to the left of it the various input signals (input) are shown and the three adjacent blocks in the lower part of FIG. 9 represent, on the one hand, detailed representations of blocks 912 and 917 from the higher-level block 910 and, on the bottom right, a list of the output signals (output) of the control device 900.

The control device 900 has two control paths, namely one for the first oscillation about the first oscillation axis A₁ of the deflection element 810 and one for the second oscillation about the second oscillation axis A₂ of the deflection element 810. Since the oscillation frequencies for the two oscillations differ normally, the first oscillation axis A₁ is referred to here, without loss of generality, as the fast axis (FAST) and the second oscillation axis A₂ as the slow axis (“SLOW”). The same applies to the corresponding signals and oscillations.

First, the switching component for the fast axis is discussed. On the input side, the control device 900 has a band filter 911 with which the input signal ADC_FAST is filtered. This input signal is a sensor signal or a signal derived therefrom that characterizes a measured position, i.e. orientation or deflection, of the deflection element (micro-mirror) 810, eg the deflection angle. It thus describes the actual oscillation curve of the deflection element 810 with respect to the fast axis A₁ and can in particular, as in the present case, be a digital signal. By filtering in the band filter 911, unwanted noise is removed on the one hand and a band limitation of the signal to a defined band range for subsequent signal processing on the other hand is achieved.

The filtered signal ADC_{down} now runs as an input signal into a digital down-converter (DDC) 925, which has a QAM block 912 (QAM=quadrature amplitude modulation) and two downstream downsamplers, one of which is a downsampler 913 for the real part Re and one downsampler 914 for the imaginary part Im, each of which reduces the clock rate by a factor of 32. The QAM block 912 is shown in more detail in the lower left area of FIG. 9. The input signal ADC_{down} is divided into a real part and an imaginary part by two demodulating mixers 931 and 932, which are operated with the same (demodulation) frequency NCO_FREQ but with a 90° phase difference, and is filtered with a low-pass filter 934 or 935 for the purpose of removing higher-frequency interference signals and sidebands, so that the aforementioned real and imaginary parts Re and Im result as output signals of the QAM block 912 and at the same time input signals of the downsamplers 913 and 914. In summary, the DDC 925 converts the band-limited input signal ADC_{down} into two partial signals of lower frequency and lower sampling rate, in particular in order to simplify the subsequent circuit stages. The two partial signals, which represent a real part and an imaginary part, respectively, together form a complex output signal which represents the measured actual course of the oscillation of the deflection element 810 with respect to the fast, first oscillation axis A₁.

From the complex output signal of the DDC 925, its phase φ is determined in a block 915 on the one hand and its magnitude |x| is determined in a block 916 on the other hand and fed into the subsequent block 917, which is referred to here as “PLL”, although it alone does not represent a PLL (phase-locked loop) in the usual sense. The PLL block 917 is shown in more detail in the lower middle part of FIG. 9. It essentially contains a PI controller 940 (proportional-integral controller) and an oscillator 941 connected downstream of this with a fixed phase position (here specified as) 0° for generating the drive signals DRIVE-FAST and PHASE FAST for the drive device (e.g. piezo drive) for driving the first, fast oscillation of the deflection element 810. The oscillator is a so-called numerically controlled oscillator (NCO). In addition, in the signal path between the PI controller 940 and the oscillator 941, the frequency NCO_FREQ of the output signal of the PI controller 940 is tapped as a frequency signal and fed back in a loop to the QAM block 912 as another input signal of the same, so that a PLL (phase-locked loop) is now formed in which this fed-back frequency signal, which represents the frequency NCO_FREQ (and is therefore also referred to here as NCO_FREQ), acts as a target variable for the phase-locked loop PLL.

Each module or block of the circuit, e.g. the PLL block 917, is connected to a clock signal CLK100. With each (usually) rising edge, the entire circuit is run through once, so that the output signals are also clocked accordingly.

A reset signal RST resets the circuit that has state-dependent outputs if it is positive with a rising edge, i.e. 1, not 0, thereby resetting the entire state of the block or all blocks.

When the micro-scanner is put into operation, the oscillation of the deflection element 810 is initially “manually driven”—that is, determined visually based on visible transient oscillation or electronically until a threshold value of the oscillation amplitude is exceeded—in the direction of the resonance frequency by setting the frequency NCO_FREQ accordingly without the aid of the control function of the controller 940.

Then, the control function of block 917 and thus the PLL or phase-locked loop as a whole is activated, and in particular, as already explained, the phase φ is determined in block 915. This phase φ describes the phase position of the actual oscillation curve serving as the reference variable of the control to the first oscillation axis A₁, which is represented by the complex output signal of the DDC 925, related to the constant (reference) phase position 0° of the drive oscillator 941.

Leaving aside signal propagation times and similar distortions, the phase φ—compare this with a Bode diagram of a PT2 element—should ideally be exactly 90° at the resonance frequency. If this is not the case, the PI controller increases or decreases the frequency (not the phase, which is constant) of the drive oscillator 941 in the correct direction until the target phase of 90° is reached.

The circuit part for the slow axis A₂ is basically constructed in the same way and functions in the same way. The difference here, however, is that due to the lower oscillation frequency on this axis, a lower clock rate is provided, so that the 920 downsampler only reduces the clock rate by a factor of two. The band filter 918 can also be designed for a correspondingly lower frequency band than the corresponding band filter 911 on the fast axis, and the QAM block 919 and optionally also the PLL block 924 can also be frequency-adjusted accordingly. Blocks 922 and 923 for determining the phase or magnitude of the output signal of the DDC on the slow axis can generally correspond unchanged to blocks 915 and 916, respectively, although frequency-dependent adjustments are also conceivable here.

FIG. 10 shows an exemplary block diagram 1000 based on FIG. 9 of a circuit for generating control signals for a drive device of a Lissajous micro-scanner with a trajectory regulation according to the solution.

Since the structure and functionality of the corresponding circuit parts for the fast axis and the slow axis are the same here, only the circuit part for the fast axis (A₁ or FAST) is discussed below as an example. According to the circuit of FIG. 9, the input signal ADC_FAST is fed to a band filter 911 and subsequently to a DDC block 925 with a QAM block 912 and two downsampling blocks 913 and 914 for the real and imaginary parts, respectively. This is followed along the signal path by a block 915 for determining the phase and a block 916 for determining the magnitude of the complex output signal of the DDC block 925.

The downstream PLL block 1017 is modified compared to block 917 of FIG. 9 such that it additionally receives a frequency correction control signal CORR_FREQ_FAST as an input signal. The signal CORR_FREQ_FAST is generated in an additional frequency correction block 1042, which is not present in FIG. 9 and ensures a regulation effect of the circuit 1000 for controlling the drive device for the fast axis A₁.

The frequency correction block 1042 receives as input signal with respect to the fast axis the frequency control signal NCO_FREQ_FAST tapped at the PLL block 1017, with which the NCO of the PLL block 1017 is controlled. The frequency control signal NCO_FREQ_FAST is converted in the frequency correction block 1042 into the adjusted frequency control signal CORR_FREQ_FAST by reading out a suitable frequency pair for adjusted frequencies for the fast axis A₁ and the slow axis A₂ from a memory, in particular a ROM, depending on NCO_FREQ_FAST and generating the adjusted frequency control signal CORR_FREQ_FAST such that it represents the adjusted frequency for the fast axis A₁ specified for this frequency pair.

For the slow axis, this is done accordingly, wherein the frequency control signal NCO_FREQ_SLOW is converted in the frequency correction block 1042 according to the method of FIG. 2 into the adjusted frequency control signal CORR_FREQ_SLOW, so that the read frequency pair is now represented by the signal pair (CORR_FREQ_FAST; CORR_FREQ_SLOW).

The adjusted frequency represented by CORR_FREQ_FAST, which was read out from the ROM, is—as already explained—fed to the QAM block 912 as an input variable in the sense of a feedback loop modified by the frequency adjustment, since the deflection element 810 is driven with this corrected frequency, which is why in order to correctly determine the phase φ in block 915, this frequency must also be used beforehand for demodulation in the QAM block 912. However, this generally results in a deviation from the ideal value of 90° for the phase φ, since due to the aforementioned frequency adjustment in block 1021 the frequency CORR_FREQ_FAST is always slightly off the current resonance frequency of the fast axis A₁. However, this deviation is usually so small that it usually plays no role in practice. The adjusted frequency represented by CORR_FREQ_FAST is also fed to the PLL block 1017.

What has been said here about the fast axis also applies to the slow axis. Overall, a discretization of the drive frequencies NCO_FREQ_FAST and NCO_FREQ_SLOW for driving the deflection element 810 thus takes place, in which only preselected frequency pairs stored in advance in the ROM are permitted, for which it is known in advance that they lead to an improved, in particular more homogeneous trajectory density and thus to a better imaging result than would be achieved without the frequency adjustment. This is especially true for longer observation periods, where temperature changes or other influencing factors on the resonance frequencies would normally come into effect.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and their legal equivalents.

### LIST OF REFERENCE NUMERALS

100 trajectory from FIG. 1
200 trajectory regulation method
205-230 steps or method sections of method 200
400 sequence of trajectory sections 401 to 409
401-409 trajectory sections
500 trajectory from FIG. 5
600 illumination of the image area in FIG. 6
700 illumination of the image area in FIG. 7
800 beam deflection system
801 micro-scanner system, in particular two-axis micro-scanner
805 radiation source
810 deflection element
815 pairs of springs
820 frame
825 control device
825a data processing device
825b storage device
830 piezo actuator
835 Lissajous figure or Lissajous trajectory
840 projection surface
900 control device without trajectory regulation
910 block (control)
911 band filter
912 QAM block
913, 914 downsampler
915 block for phase determination
916 block 916 for determining the magnitude of the complex output signal of the DDC block 925
917 PLL block
918 band filter
919 QAM block
920, 921 downsampler
922 block for phase determination
923 block 916 for magnitude determination
924 PLL block
925 DDC block
930, 933 oscillator
931, 932 mixer
934, 935 low-pass filter
940 PI controller
941 drive oscillator
1000 control device with trajectory regulation
1010 block (control)
1017 PLL block
1024 PLL block
1042 frequency correction block

What is claimed is:

1. A method for trajectory regulation in a multi-axis micro-scanner system, wherein the method comprises:
controlling a drive device for the micro-scanner system in such a way that the latter is caused to drive a first rotary oscillation of a deflection element of the micro-scanner system about a first oscillation axis by means of an excitation with a first drive frequency and, simultaneously with the first oscillation, a second rotary oscillation of a deflection element of the micro-scanner system about a second oscillation axis orthogonal to the first oscillation axis by means of an excitation with a second drive frequency, wherein the control takes place over a plurality of successive time intervals in the sense of a regulation, in such a way that:
in each of the time intervals for its respective duration, the first and the second drive frequency are each kept stable at a respective specific first and second target frequency, wherein these two target frequencies form a frequency pair associated with this time interval and the respectively assigned frequency pairs of at least two immediately consecutive time intervals differ from one another with respect to the first target frequency and/or the second target frequency; and
for a respective time interval, the frequency pair associated with it is selected from a predetermined discrete set of several different frequency pairs according to a selection rule as a function of a sensor-detected value of at least one physical variable which is in a dependency relationship with the respective resonance frequency with respect to at least one of the oscillation axes, such that the selected frequency pair deviates with respect to at least one of its two frequencies by a respective frequency deviation from the resonance frequency relative to the same oscillation axis according to the dependency relationship with the detected value of the at least one variable.

2. The method according to claim 1, wherein, according to the selection rule for the respective time interval, that frequency pair is selected from the set which, with respect to at least one of its two frequencies, has a frequency deviation from the resonance frequency to the same oscillation axis which is different from zero and minimal within the set and which corresponds to the detected value of the at least one variable according to the dependency relationship.

3. The method according to claim 1, wherein the respective duration of each time interval corresponds to at least 50%, in particular at least 80%, preferably at least 90%, of the duration of a phase pass of a Lissajous trajectory caused by a reflecting deflection of an electromagnetic beam incident on the micro-scanner system during the simultaneous oscillations into an observation field according to the frequency pair associated with the respective time interval.

4. The method according to claim 1, further comprising:
determining at least one frequency pair {f₁; f₂} of the set depending on:
the resonance frequency f_{r,1} of the micro-scanner system for the first oscillation axis;
the resonance frequency f_{r,2} of the micro-scanner system for the second oscillation axis; and
at least one predetermined line spacing value or an upper limit defined therefor, which characterizes a maximum line spacing between adjacent lines of the Lissajous trajectory occurring during a complete phase pass.

5. The method according to claim 4, wherein the determination of the at least one frequency pair {f₁; f₂} is carried out starting from a phase pass frequency fᵣₑₛ which corresponds to a closed Lissajous trajectory for a pair {f_{0,1},f_{0,2}} of possible resonance frequencies of the micro-scanner system for the two oscillations and comprises:
determining a lower limit for a first factor n₁ associated with the first oscillation axis and/or a second factor n₂ associated with the second oscillation axis, each as a function of a line spacing value associated with the respective oscillation axis or the upper limit defined therefor, wherein n₁, n₂≥1 are each integers; and
determining the at least one frequency pair {f₁; f₂} in such a way that for this frequency pair or each of these frequency pairs the following conditions apply:
f₁≤f_{0,1}/n₁
f₂≤f_{0,2}/n₂; and
n₁, n₂ are coprimes.

6. The method according to a claim 1, further comprising:
determining at least one frequency pair {f₁; f₂} of the set such that, starting from a phase pass frequency fᵣₑₛ, which corresponds to a closed Lissajous trajectory for a pair {f_{0,1},f_{0,2}} of possible resonance frequencies of the micro-scanner system for the two oscillations, and with |n_{Δ}|>0, the following applies:
$${f}_{1} = {f}_{0 , 1} + Δ {f}_{1} with Δ {f}_{1} = \frac{1}{{n}_{Δ} \cdot {n}_{2}} \cdot {f}_{res}$$
$${f}_{2} = {f}_{0 , 2} + Δ {f}_{2} with Δ {f}_{2} = \frac{1}{{n}_{Δ} \cdot {n}_{1}} \cdot {f}_{res} ,$$
wherein and n₁, n₂≥1 are each integers and coprimes, so that the following applies:
f_{0,1}=n₁·fᵣₑₛ and f_{0,2}=n₂·fᵣₑₛ.

7. The method according to claim 1, further comprising:
modulating the electromagnetic beam by means of an image signal as a function of the instantaneous deflection of the beam such that the Lissajous projection with a specific image resolution of N matrix-shaped pixels images a two-dimensional digital image or a sequence of such images into the observation field;
wherein, according to the selection rule, for at least one of the time intervals, the frequency pair associated with it is selected from the set in such a way that within a maximum of five immediately consecutive phase passes, each of the N pixels with the image resolution is imaged onto the observation surface.

8. The method according to claim 7, wherein, during the respective duration of each time interval, the duration of a phase pass of a Lissajous trajectory according to the frequency pair associated with the respective time interval is shorter than a shortest projection duration per image occurring during the respective time interval in a Lissajous projection by means of the micro-scanner system.

9. The method according to claim 7, wherein, according to the selection rule for at least one of the time intervals, the selection of the frequency pair associated with it from the set is carried out such that the selected frequency pair corresponds to a Lissajous trajectory resulting from the Lissajous projection, which trajectory passes through at least 90%, preferably at least 95% of the N pixels during a complete phase pass.

10. The method according to claim 1, wherein the physical variable characterizes or depends on one of the following states of the micro-scanner system or a combination of at least two of these states or state changes:
a shift of a measured resonance frequency of at least one of the oscillations;
a temperature;
a mechanical stress or strain;
an oscillation amplitude of the or a deflection element;
a phase instability occurring in at least one of the oscillations;
one of the respective target variables of a phase-locked loop for the phase of at least one of the oscillations;
a phase difference between a drive signal for controlling the drive device and a measurement signal representing a measured deflection of the deflection element;
a change in the incident electromagnetic radiation power which the deflection element receives by absorption;
a change in an oscillation state of a reference oscillator in the micro-scanner system, which is correlated with an oscillation state of the or at least one deflection element.

11. The method according to claim 1, wherein the value of the at least one physical variable depending on which the selection of the respective associated frequency pair for a respective time interval is made is detected during the time interval immediately preceding that time interval.

12. The method according to any one claim 1, wherein the change between successive time intervals within the scope of the control takes place at a time at which the trajectory of the Lissajous projection has a distance from the center of the observation field illuminated by the trajectory within its complete phase pass, which corresponds to at least 80% of the maximum occurring distance of a point on the trajectory from the center.

13. (canceled)

14. The method according to claim 1, wherein the frequency pairs of the discrete set are stored in advance in a storage device and from this, for at least one of the time intervals, its associated frequency pair is selected as a function of the sensor-detected value of the at least one physical variable according to the selection rule for each time interval.

15. The method according to claim 1, wherein in the context of the control for at least one of the time intervals, the associated frequency pair is determined dynamically during the method by means of a calculation rule, which is determined by the selection rule and defines the discrete set, as a function of the sensor-detected value of the at least one physical variable.

16. The method according to claim 1, wherein in addition to selecting a respective associated frequency pair for each time interval, a target amplitude gain associated with this time interval is also selected with respect to at least one of the two oscillation axes; and
during the respective time interval, the drive device is controlled including a respective amplitude amplification configured by the associated target amplitude gain with respect to this at least one oscillation axis.

17. The method according to claim 1, wherein:
the micro-scanner system is configurable such that its respective resonance frequency can be detuned with respect to at least one of the oscillation axes by appropriately adjusting at least one configuration parameter of the micro-scanner system; and
for at least one of the time intervals, in addition to selecting a respective associated frequency pair, a resonance frequency detuning of the micro-scanner system with respect to the at least one oscillation axis is carried out by setting the at least one configuration parameter.

18. A control device for trajectory regulation of one of the micro-scanner systems, wherein the control device is configured to control a drive device for a micro-scanner system according to the method according to claim 1.

19. The control device according to claim 18, comprising for at least one of the two oscillation axes:
a phase-locked loop for stabilizing a phase difference between a phase of the first or second oscillation, respectively, which corresponds to the oscillation axis and a corresponding drive signal output from the phase-locked loop for the drive device with respect to the oscillation axis; and
a frequency adjustment device for the phase-locked loop, which is configured to adjust a reference variable of the phase-locked loop in dependence on a target frequency determined for this time interval according to the method with respect to the oscillation axis.

20. A non-transitory computer-readable storage medium including instructions that, when executed by the control device of claim 17; cause the control device to carry out a method comprising:
controlling a drive device for the micro-scanner system in such a way that the latter is caused to drive a first rotary oscillation of a deflection element of the micro-scanner system about a first oscillation axis by means of an excitation with a first drive frequency and, simultaneously with the first oscillation, a second rotary oscillation of a deflection element of the micro-scanner system about a second oscillation axis orthogonal to the first oscillation axis by means of an excitation with a second drive frequency, wherein the control takes place over a plurality of successive time intervals in the sense of a regulation, in such a way that:
in each of the time intervals for its respective duration, the first and the second drive frequency are each kept stable at a respective specific first and second target frequency, wherein these two target frequencies form a frequency pair associated with this time interval and the respectively assigned frequency pairs of at least two immediately consecutive time intervals differ from one another with respect to the first target frequency and/or the second target frequency; and
for a respective time interval, the frequency pair associated with it is selected from a predetermined discrete set of several different frequency pairs according to a selection rule as a function of a sensor-detected value of at least one physical variable which is in a dependency relationship with the respective resonance frequency with respect to at least one of the oscillation axes, such that the selected frequency pair deviates with respect to at least one of its two frequencies by a respective frequency deviation from the resonance frequency relative to the same oscillation axis according to the dependency relationship with the detected value of the at least one variable.

21. A beam deflection system, comprising:
a multi-axis micro-scanner system with at least one deflection element, which can carry out a first rotational oscillation around a first oscillation axis and with at least one deflection element which can carry out a second rotational oscillation around a second oscillation axis orthogonal to the first oscillation axis, simultaneously with the first oscillation, in order to be able to cause a Lissajous projection in an observation field by reflective deflection of an electromagnetic beam incident on the micro-scanner system during the simultaneous oscillations;
a drive device for driving at least one of the oscillations of the micro-scanner system; and
a control device for controlling the drive device according to a method comprising:
controlling the drive device for the micro-scanner system in such a way that the latter is caused to drive a first rotary oscillation of a deflection element of the micro-scanner system about a first oscillation axis by means of an e % citation with a first drive frequency and, simultaneously with the first oscillation, a second rotary oscillation of a deflection element of the micro-scanner system about a second oscillation axis orthogonal to the first oscillation axis by means of an excitation with a second drive frequency, wherein the control takes place over a plurality of successive time intervals in the sense of a regulation, in such a way that;
in each of the time intervals for its respective duration the first and the second drive frequency are each kept stable at a respective specific first and second target frequency, wherein these two target frequencies form a frequency pair associated with this time interval and the respectively assigned frequency pairs of at least two immediately consecutive time intervals differ from one another with respect to the first target frequency and/or the second target frequency; and
for a respective time interval, the frequency pair associated with it is selected from a predetermined discrete set of several different frequency pairs according to a selection rule as a function of a sensor-detected value of at least one physical variable which is in a dependency relationship with the respective resonance frequency with respect to at least one of the oscillation axes, such that the selected frequency pair deviates with respect to at least one of its two frequencies by a respective frequency deviation from the resonance frequency relative to the same oscillation axis according to the dependency relationship with the detected value of the at least one variable.

22. (canceled)
